(19) United States
(12) Patent Application Publication
(10) Pub. No.: US 2011/0062925 A1
(43) Pub. Date: Mar. 17, 2011

(54) VOLTAGE RANGE DETERMINATION CIRCUIT AND METHODS THEREOF

(75) Inventors: Byung-Hun HAN, Seoul (KR); Seung-Hoon BAEK, Suwon-si (KR)

(73) Assignee: SAMSUNG ELECTRONICS CO., LTD., Suwon-si (KR)

(21) Appl. No.: 12/851,667

(22) Filed: Aug. 6, 2010

(30) Foreign Application Priority Data
Sep. 14, 2009 (KR) 10-2009-0086270

(51) Int. Cl. G05F 1/10

(52) U.S. Cl. 323/282

(57) ABSTRACT

A voltage range determination circuit may include an object voltage generating unit that generates an object voltage corresponding to a scaled-down voltage of an input voltage based on the input voltage, a selection voltage generating unit that generates a first selection voltage and a second selection voltage that is greater than the first selection voltage based on a reference voltage, a comparison voltage selecting unit that selects one of the first selection voltage and the second selection voltage as a comparison voltage based on an output signal, and an output signal generating unit that compares the object voltage with the comparison voltage to generate the output signal.

### CROSS-REFERENCE TO RELATED APPLICATION(S)

This application claims priority from Korean Patent Application No. 10-2009-0086270, filed on Sep. 14, 2009, in the Korean Intellectual Property Office, the contents of which are incorporated herein in its entirety by reference.

### FIELD

Exemplary embodiments relate to an electric device, and more particularly to a voltage range determination circuit for a display device of an electric device and methods thereof.

### SUMMARY

Recently, as an electric device requires small size and low power consumption, a display device in the electric device may not include a low drop out (LDO) voltage regulator. That is, a power voltage output from a battery may be directly provided into the display device without the LDO voltage regulator. Generally, the power voltage may decrease as the electric device operates, and may increase as the battery is charged. Thus, the display device without the LDO voltage regulator needs to generate a plurality of display driving voltages by changing a voltage gain based on a voltage range of the power voltage.

To determine the voltage range of the power voltage, conventional display devices divide an output range of the battery to set divided voltage ranges. Then, the conventional display devices determined the voltage range of the power voltage by checking where (i.e., within what divided voltage range) the power voltage is. However, the conventional display devices may misdetermine the voltage range of the power voltage at boundaries of the divided voltage ranges when the power voltage fluctuates due to external noise. As a result, the conventional display devices may not successfully generate the display driving voltages.

Exemplary embodiments provide a voltage range determination circuit capable of precisely determining a voltage range of an input voltage that is variable (e.g., a power voltage output from a battery) even when noise is input from outside and methods thereof.

Exemplary embodiments provide a voltage supply circuit having the voltage range determination circuit.

According to some exemplary embodiments, a voltage range determination circuit may include an object voltage generating unit that generates an object voltage corresponding to a scaled-down voltage of an input voltage based on the input voltage, a selection voltage generating unit that generates a first selection voltage and a second selection voltage that is greater than the first selection voltage based on a reference voltage, a comparison voltage selecting unit that selects one of the first selection voltage and the second selection voltage as a comparison voltage based on an output signal, and an output signal generating unit that compares the object voltage with the comparison voltage to generate the output signal.

In some exemplary embodiments, a plurality of divided object voltage ranges for determining a voltage range of the object voltage may include a first object voltage range and a second object voltage range, and the voltage range of the object voltage may be determined based on a logic state of the output signal.

In some exemplary embodiments, the first object voltage range and the second object voltage range may be changed by a voltage range hysteresis period based on the logic state of the output signal.

In some exemplary embodiments, the voltage range hysteresis period may correspond to a difference between the first selection voltage and the second selection voltage.

In some exemplary embodiments, a plurality of divided input voltage ranges for determining a voltage range of the input voltage may include a first input voltage range and a second input voltage range, and the first input voltage range and the second input voltage range may be determined by scaling up the first object voltage range and the second object voltage range, respectively.

In some exemplary embodiments, at a time when the object voltage is smaller than the comparison voltage as the input voltage decreases, the first object voltage range may become narrower by the voltage range hysteresis period, and the second object voltage range may become wider by the voltage range hysteresis period.

In some exemplary embodiments, at a time when the object voltage is greater than the comparison voltage as the input voltage increases, the first object voltage range may become wider by the voltage range hysteresis period, and the second object voltage range may become narrower by the voltage range hysteresis period.

In some exemplary embodiments, the object voltage may be determined to be within the first object voltage range when the output signal has a first logic state, and the object voltage may be determined to be within the second object voltage range when the output signal has a second logic state.

In some exemplary embodiments, the input voltage may be determined to be within the first input voltage range when the object voltage is determined to be within the first object voltage range, and the input voltage may be determined to be within the second input voltage range when the object voltage is determined to be within the second object voltage range.

In some exemplary embodiments, the object voltage generating unit may be implemented by a plurality of resistors that generate the object voltage by performing a voltage division on the input voltage.

In some exemplary embodiments, the selection voltage generating unit may be implemented by a plurality of resistors that generate the first selection voltage and the second selection voltage by performing a voltage division on the reference voltage.

In some exemplary embodiments, the comparison voltage selecting unit may be implemented by a multiplexer that selectively outputs the first selection voltage or the second selection voltage as the comparison voltage based on the output signal.

In some exemplary embodiments, the output signal generating unit may be implemented by a comparator that compares the object voltage with the comparison voltage to generate the output signal.

According to some exemplary embodiments, a voltage range determination circuit may include an object voltage generating unit that generates an object voltage corresponding to a scaled-down voltage of an input voltage by performing a voltage division on the input voltage, a selection voltage generating unit that generates a first through nth selection voltage group having a plurality of selection voltages, respectively by performing a voltage division on a reference voltage, a comparison voltage selecting unit that selects one of the selection voltages as a first through nth comparison voltage for the first through nth selection voltage group based on a first through nth output signal, respectively, and an output signal generating unit that compares the object voltage with the first through nth comparison voltage to generate the first through nth output signal.

In some exemplary embodiments, a plurality of divided object voltage ranges for determining a voltage range of the object voltage may include a first through (n+1)th object voltage range, and the voltage range of the object voltage may be determined based on logic states of the first through nth output signal.

In some exemplary embodiments, the first through (n+1)th object voltage range may be changed based on the logic states of the first through nth output signal.

In some exemplary embodiments, a first through nth voltage range hysteresis period may correspond to each difference between the selection voltages of the first through nth selection voltage group, respectively.

In some exemplary embodiments, a plurality of divided input voltage ranges for determining a voltage range of the input voltage may include a first through nth input voltage range, and the first through nth input voltage range may be determined by scaling up the first through nth object voltage range, respectively.

According to some exemplary embodiments, a voltage range determination circuit may precisely determined a voltage range of an input voltage that is variable (e.g., a power voltage output from a battery) even when noise is input from outside.

According to some exemplary embodiments, a voltage supply circuit having the voltage range determination circuit may provide an output voltage that is substantially stable based on an input voltage that is variable (e.g., a power voltage output from a battery).

In some exemplary embodiments, there is a method for a providing a steady output voltage, the method including: generating an object voltage based on a portion of an output voltage of a voltage source; generating a first selection voltage and a second selection voltage based on a reference voltage, the first selection voltage being smaller than the second selection voltage; selecting one of the first selection voltage and the second selection voltage as a comparison voltage; comparing the object voltage with the comparison voltage to generate an output signal; and amplifying the object voltage based on the output signal, wherein the selecting the one of the first and the second selection voltages as the comparison voltage is based on the output signal that is fed back.

In the adaptively changing the comparison voltage according to a predetermined voltage amount, if the object voltage decreases below than the comparison voltage, the comparison voltage is increased by the predetermined amount; and the decreased object voltage that is fluctuating, is compared with the increased comparison voltage to generate the output signal.

In the adaptively changing the comparison voltage according to a predetermined voltage amount, if the object voltage increases above than the comparison voltage, the comparison voltage is decreased by the predetermined amount; and the increased object voltage that is fluctuating, is compared with the decreased comparison voltage to generate the output signal.

### BRIEF DESCRIPTION OF THE DRAWINGS

Illustrative, non-limiting exemplary embodiments will be more clearly understood from the following detailed description taken in conjunction with the accompanying drawings.

FIG. 1 is a block diagram illustrating a voltage range determination circuit according to some exemplary embodiments.

FIG. 2 is a flow chart illustrating operations of a voltage range determination circuit of FIG. 1 as an input voltage decreases.

FIG. 3 is a graph illustrating operations of a voltage range determination circuit of FIG. 1 as an input voltage decreases.

FIG. 4 is a flow chart illustrating operations of a voltage range determination circuit of FIG. 1 as an input voltage increases.

FIG. 5 is a graph illustrating operations of a voltage range determination circuit of FIG. 1 as an input voltage increases.

FIG. 6 is a block diagram illustrating a voltage supply circuit having a voltage range determination circuit of FIG. 1.

FIG. 7 is a block diagram illustrating a display driving voltage generator having a voltage supply circuit of FIG. 6.

FIG. 8 is a block diagram illustrating a voltage range determination circuit according to some exemplary embodiments.

FIGS. 9A and 9B are flow charts illustrating operations of a voltage range determination circuit of FIG. 8 as an input voltage decreases.

FIG. 10 is a first graph illustrating operations of a voltage range determination circuit of FIG. 8 as an input voltage decreases.

FIG. 11 is a second graph illustrating operations of a voltage range determination circuit of FIG. 8 as an input voltage decreases.

FIG. 12 is a third graph illustrating operations of a voltage range determination circuit of FIG. 8 as an input voltage decreases.

FIG. 13 is a graph illustrating a first through fourth object voltage range changed by a voltage range determination circuit of FIG. 8 as an input voltage decreases.

FIGS. 14A and 14B are flow charts illustrating operations of a voltage range determination circuit of FIG. 8 as an input voltage increases.

FIG. 15 is a first graph illustrating operations of a voltage range determination circuit of FIG. 8 as an input voltage increases.

FIG. 16 is a second graph illustrating operations of a voltage range determination circuit of FIG. 8 as an input voltage increases.

FIG. 17 is a third graph illustrating operations of a voltage range determination circuit of FIG. 8 as an input voltage increases.

FIG. 18 is a graph illustrating a first through fourth object voltage range changed by a voltage range determination circuit of FIG. 8 as an input voltage increases.

FIG. 19 is a block diagram illustrating a voltage supply circuit having a voltage range determination circuit of FIG. 8.

FIG. 20 is a block diagram illustrating a display driving voltage generator having a voltage supply circuit of FIG. 19.

FIG. 21 is a block diagram illustrating an exemplary of a display device having a display driving voltage generator according to some exemplary embodiments.

### DETAILED DESCRIPTION OF THE EXEMPLARY EMBODIMENTS

Various exemplary embodiments will be described more fully hereinafter with reference to the accompanying drawings, in which some exemplary embodiments are shown. The present inventive concept may, however, be embodied in many different forms and should not be construed as limited to the exemplary embodiments set forth herein. Rather, these exemplary embodiments are provided so that this disclosure will be thorough and complete, and will fully convey the scope of the present inventive concept to those skilled in the art. In the drawings, the sizes and relative sizes of layers and regions may be exaggerated for clarity. Like numerals refer to like elements throughout.

It will be understood that, although the terms first, second, third etc. may be used herein to describe various elements, these elements should not be limited by these terms. These terms are used to distinguish one element from another. Thus, a first element discussed below could be termed a second element without departing from the teachings of the present inventive concept. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular exemplary embodiments only and is not intended to be limiting of the present inventive concept. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

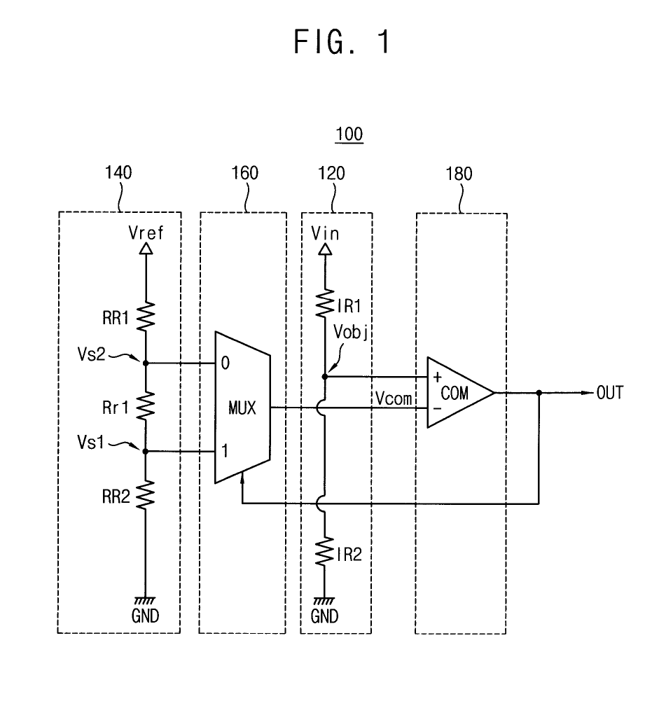

FIG. 1 is a block diagram illustrating a voltage range determination circuit according to some exemplary embodiments.

Referring to FIG. 1, the voltage range determination circuit 100 may include an object voltage generating unit 120, a selection voltage generating unit 140, a comparison voltage selecting unit 160, and an output signal generating unit 180.

The object voltage generating unit 120 generates an object voltage Vobj based on an input voltage Vin. The object voltage Vobj corresponds to a scaled-down voltage of the input voltage Vin. In an exemplary embodiment, the object voltage generating unit 120 performs a voltage division on the input voltage Vin using a plurality of resistors IR1 and IR2 such that the object voltage generating unit 120 may generate the object voltage Vobj. Generally, the input voltage Vin input to electric devices (e.g., a power voltage output from a battery) may be relatively high when compared to a desired voltage range or may be outside of the desired voltage range for the electric devices. Thus, the object voltage generating unit 120 may scale down the input voltage Vin to generate the object voltage Vobj that is within a voltage range for use in the voltage range determination circuit 100. However, if the input voltage Vin is within the voltage range for use in the voltage range determination circuit 100, the object voltage generating unit 120 may not scale down the input voltage Vin. That is, the object voltage Vobj may be substantially the same as the input voltage Vin if the input voltage Vin is within the voltage range for use in the voltage range determination circuit 100. In an exemplary embodiment, the object voltage generating unit 120 may perform the voltage division on the input voltage Vin using variable resistive elements (e.g., variable resistors) instead of the resistors IR1 and IR2. In an exemplary embodiment, the object voltage generating unit 120 may perform the voltage division on the input voltage Vin using active elements (e.g., diodes) instead of the resistors IR1 and IR2.

The selection voltage generating unit 140 generates a first selection voltage Vs1 and a second selection voltage Vs2 based on a reference voltage Vref. The first selection voltage Vs1 is smaller than the second selection voltage Vs2. In an exemplary embodiment, the selection voltage generating unit 140 performs a voltage division on the reference voltage Vref using a plurality of resistors RR1, RR2, and Rr1 such that the selection voltage generating unit 140 may generate the first selection voltage Vs1 and the second selection voltage Vs2. One of the first selection voltage Vs1 and the second selection voltage Vs2 is output as a comparison voltage Vcom. A plurality of divided object voltage ranges for determining a voltage range of the object voltage may include a first object voltage range and a second object voltage range. The first object voltage range may be from the comparison voltage Vcom to the reference voltage Vref. The second object voltage range may be from a ground voltage GND to the comparison voltage Vcom. A difference between the first selection voltage Vs1 and the second selection voltage Vs2 corresponds to a voltage range hysteresis period that is set at about a boundary the divided object voltage ranges (i.e., the first object voltage range and the second object voltage range). Thus, the selection voltage generating unit 140 adjusts the difference between the first selection voltage Vs1 and the second selection voltage Vs2 to control the voltage range hysteresis period. In an exemplary embodiment, the selection voltage generating unit 140 may perform the voltage division on the reference voltage Vref using variable resistive elements instead of the resistors RR1, RR2, and Rr1. In an exemplary embodiment, the selection voltage generating unit 140 may perform the voltage division on the input voltage Vref using active elements (e.g., diodes) instead of the resistors RR1, RR2, and Rr1.

The comparison voltage selecting unit 160 selects one of the first selection voltage Vs1 and the second selection voltage Vs2 based on an output signal OUT to output the selected one as the comparison voltage Vcom. The output signal OUT is fed back from the output signal generating unit 180. In an exemplary embodiment, the comparison voltage selecting unit 160 may be implemented by a multiplexer that selectively outputs the first selection voltage Vs1 or the second selection voltage Vs2 as the comparison voltage Vcom based on the output signal OUT. For example, the comparison voltage selecting unit 160 may output the first selection voltage Vs1 when the output signal OUT has a first logic state (e.g., logic “HIGH” state), and may output the second selection voltage Vs2 when the output signal OUT has a second logic state (e.g., logic “LOW” state). That is, the comparison voltage selecting unit 160 may change the first object voltage range and the second object voltage range by switching the comparison voltage Vcom between the first selection voltage Vs1 and the second selection voltage Vs2. In an exemplary embodiment, the comparison voltage selecting unit 160 may have a structure in which one selection voltage is selected among at least three selection voltages based on the output signal OUT if the selection voltage generating unit 140 generates the at least three selection voltages.

The output signal generating unit 180 compares the object voltage Vobj with the comparison voltage Vcom to generate the output signal OUT corresponding to comparison results. In an exemplary embodiment, the output signal generating unit 180 may be implemented by a comparator that compares the object voltage Vobj with the comparison voltage Vcom to generate the output signal OUT. For example, the output signal generating unit 180 may generate the output signal OUT having the first logic state (e.g., logic “HIGH” state) when the object voltage Vobj is greater than the comparison voltage Vcom, and may generate the output signal OUT having the second logic state (e.g., logic “LOW” state) when the object voltage Vobj is smaller than the comparison voltage Vcom. Here, the voltage range of the object voltage Vobj may be determined based on the logic state of the output signal OUT. For example, the object voltage Vobj may be determined to be within the first object voltage range when the output signal OUT has the first logic state (e.g., logic “HIGH” state), and may be determined to be within the second object voltage range when the output signal OUT has the second logic state (e.g., logic “LOW” state). That is, the output signal generating unit 180 may indicate that the object voltage Vobj is within the first object voltage range by outputting the output signal OUT having the first logic state (e.g., logic “HIGH” state) when the object voltage Vobj is greater than the comparison voltage Vcom. On the other hand, the output signal generating unit 180 may indicate that the object voltage Vobj is within the second object voltage range by outputting the output signal OUT having the second logic state (e.g., logic “LOW” state) when the object voltage Vobj is smaller than the comparison voltage Vcom.

According to an exemplary embodiment, at a time when the object voltage Vobj becomes smaller than the comparison voltage Vcom as the input voltage Vin decreases (e.g., an electric device operates), the first object voltage range becomes narrower by the voltage range hysteresis period, and the second object voltage range becomes wider by the voltage range hysteresis period. On the other hand, at a time when the object voltage Vobj becomes greater than the comparison voltage Vcom as the input voltage Vin increases (e.g., a battery is charged), the first object voltage range becomes wider by the voltage range hysteresis period, and the second object voltage range becomes narrower by the voltage range hysteresis period. For example, at the time when the object voltage Vobj becomes smaller than the comparison voltage Vcom as the input voltage Vin decreases (e.g., an electric device operates), the voltage range determination circuit 100 may switch the comparison voltage Vcom from the first selection voltage Vs1 to the second selection voltage Vs2. On the other hand, at the time when the object voltage Vobj becomes greater than the comparison voltage Vcom as the input voltage Vin increases (e.g., a battery is charged), the voltage range determination circuit 100 may switch the comparison voltage Vcom from the second selection voltage Vs2 to the first selection voltage Vs1. As a result, the voltage range determination circuit 100 may precisely determine the voltage range of the object voltage Vobj.

Further, a voltage range of the input voltage Vin may be determined by scaling up the voltage range of the object voltage Vobj because the object voltage Vobj is generated by scaling down the input voltage Vin. A plurality of divided input voltage ranges for determining the voltage range of the input voltage Vin may include a first input voltage range and a second input voltage range. The first input voltage range and the second input voltage range are determined by scaling up the first object voltage range and the second object voltage range, respectively. For example, the input voltage Vin may be determined to be within the first input voltage range when the object voltage Vobj is determined to be within the first object voltage range, and the input voltage Vin may be determined to be within the second input voltage range when the object voltage Vobj is determined to be within the second object voltage range. Thus, even when the input voltage Vin fluctuates due to external noise, the voltage range determination circuit 100 may precisely determine the voltage range of the input voltage Vin by setting the divided object voltage ranges, by setting the voltage range hysteresis period at the boundary of the divided object voltage ranges, by determining the voltage range of the object voltage Vobj based on the divided object voltage ranges, and by scaling up the voltage range of the object voltage Vobj.

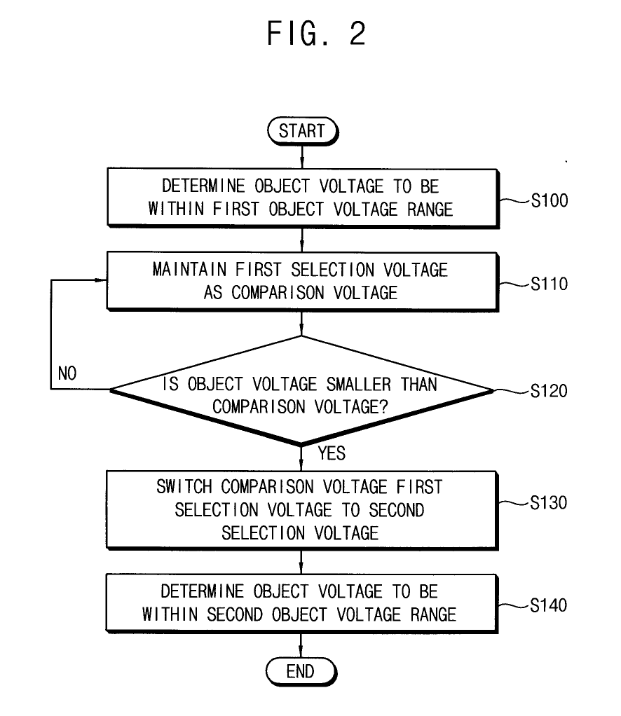

FIG. 2 is a flow chart illustrating operations of a voltage range determination circuit of FIG. 1 as an input voltage decreases.

Referring to FIG. 2, as the input voltage Vin decreases, the voltage range determination circuit 100 determines the object voltage Vobj to be within the first object voltage range (Step S100) when the object voltage Vobj becomes greater than the first selection voltage Vs1 selected as the comparison voltage Vcom. Thus, the input voltage Vin may be determined to be within the first input voltage range. The voltage range determination circuit 100 maintains the first selection voltage Vs1 as the comparison voltage Vcom (Step S110) before the object voltage Vobj becomes smaller than the first selection voltage Vs1 selected as the comparison voltage Vcom. The voltage range determination circuit 100 determines whether the object voltage Vobj becomes smaller than the first selection voltage Vs1 selected as the comparison voltage Vcom (Step S120). The voltage range determination circuit 100 switches the comparison voltage Vcom from the first selection voltage Vs1 to the second selection voltage Vs2 (Step S130) at the time when the object voltage Vobj becomes smaller than the first selection voltage Vs1 selected as the comparison voltage Vcom. The second selection voltage Vs2 is greater than the first selection voltage Vs1. Then, the voltage range determination circuit 100 determines the object voltage Vobj to be within the second object voltage range (Step S140). Thus, the input voltage Vin may be determined to be within the second input voltage range.

As described above, since the object voltage Vobj is much smaller than the comparison voltage Vcom after the comparison voltage Vcom is switched from the first selection voltage Vs1 to the second selection voltage Vs2, the voltage range of the object voltage Vobj (i.e., the input voltage Vin) may be precisely determined even when the object voltage Vobj (i.e., the input voltage Vin) fluctuates due to external noise. In detail, as the input voltage Vin decreases, the voltage range determination circuit 100 sets the first object voltage range to be from the first selection voltage Vs1 to the reference voltage Vref before the object voltage Vobj becomes smaller than the first selection voltage Vs1 selected as the comparison voltage Vcom. Then, the voltage range determination circuit 100 sets the first object voltage range to be from the second selection voltage Vs2 to the reference voltage Vref after the object voltage Vobj becomes smaller than the first selection voltage Vs1 selected as the comparison voltage Vcom. In addition, as the input voltage Vin decreases, the voltage range determination circuit 100 sets the second object voltage range to be from the ground voltage GND to the first selection voltage Vs1 before the object voltage Vobj becomes smaller than the first selection voltage Vs1 selected as the comparison voltage Vcom. Then, the voltage range determination circuit 100 sets the second object voltage range to be from the ground voltage GND to the second selection voltage Vs2 after the object voltage Vobj becomes smaller than the first selection voltage Vs1 selected as the comparison voltage Vcom. That is, at the time when the object voltage Vobj becomes smaller than the first selection voltage Vs1 selected as the comparison voltage Vcom as the input voltage Vin decreases, the first object voltage range may become narrower by the voltage range hysteresis period, and the second voltage range may become wider by the voltage range hysteresis period.

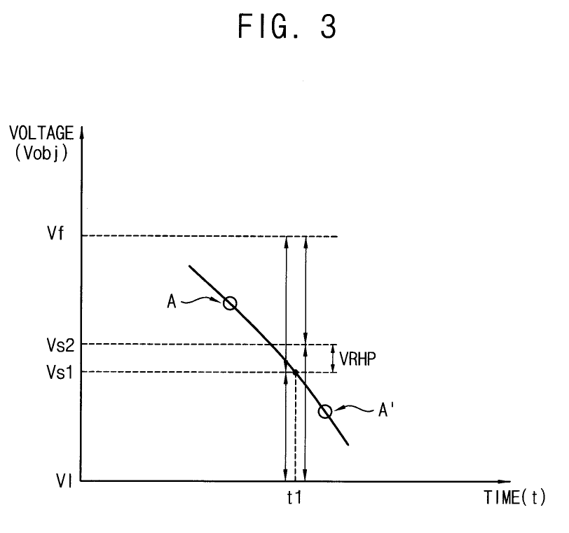

FIG. 3 is a graph illustrating operations of a voltage range determination circuit of FIG. 1 as an input voltage decreases.

Referring to FIG. 3, the voltage range determination circuit 100 generates the object voltage Vobj by scaling down the input voltage Vin. Before the object voltage Vobj becomes smaller than the first selection voltage Vs1 selected as the comparison voltage Vcom (i.e., when the object voltage Vobj has a first voltage level A), the first object voltage range is set to be from the first selection voltage Vs1 to a maximum voltage Vf (e.g., the reference voltage Vref), and the second object voltage range is set to be from a minimum voltage V1 (e.g., the ground voltage GND) to the first selection voltage Vs1. Thus, even when the input voltage Vin fluctuates due to external noise, the object voltage Vobj may be determined to be within the first object voltage range before the object voltage Vobj becomes smaller than the first selection voltage Vs1 at a first time t1. Then, after the object voltage Vobj becomes smaller than the first selection voltage Vs1 at the first time t1 (i.e., when the object voltage Vobj has a second voltage level A′), the first object voltage range is set to be from the second selection voltage Vs2 to the maximum voltage Vf (e.g., the reference voltage Vref), and the second voltage range is set to be from the minimum voltage V1 (e.g., the ground voltage GND) to the second selection voltage Vs2. Thus, even when the input voltage Vin fluctuates due to external noise, the object voltage Vobj may be determined to be within the second object voltage range after the object voltage Vobj becomes smaller than the first selection voltage Vs1 at the first time t1.

Generally, as noise is input from outside, the input voltage Vin may fluctuate. Thus, the object voltage Vobj generated by scaling down the input voltage Vin may also fluctuate. As a result, the object voltage Vobj having the first voltage level A may be determined to be within the second object voltage range due to external noise near the first time t1 although the object voltage Vobj having the first voltage level A should be determined to be within the first object voltage range. Similarly, the object voltage Vobj having the second voltage level A′ may be determined to be within the first object voltage range due to external noise near the first time t1 although the object voltage Vobj having the second voltage level A′ should be determined to be within the second object voltage range. Thus, the voltage range determination circuit 100 sets the voltage range hysteresis period VRHP at the boundary of the divided object voltage ranges (e.g., the first object voltage range and the second object voltage range) such that the voltage range determination circuit 100 may precisely determine the object voltage Vobj having the first voltage level A to be within the first object voltage range, and the object voltage Vobj having the second voltage level A′ to be within the second object voltage range even when the object voltage Vobj fluctuates due to external noise. The voltage range hysteresis period VRHP may be controlled by adjusting the difference between the first selection voltage Vs1 and the second selection voltage Vs2. As described above, the voltage range of the input voltage Vin may be determined by scaling up the voltage range of the object voltage Vobj.

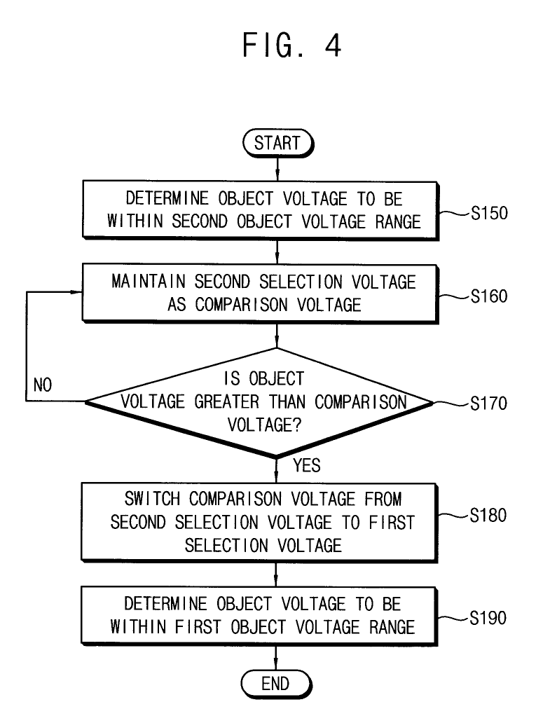

FIG. 4 is a flow chart illustrating operations of a voltage range determination circuit of FIG. 1 as an input voltage increases.

Referring to FIG. 4, as the input voltage Vin increases, the voltage range determination circuit 100 determines the object voltage Vobj to be within the second object voltage range (Step S150) when the object voltage Vobj is lower than the second selection voltage Vs2 selected as the comparison voltage Vcom. Thus, the input voltage Vin may be determined to be within the second input voltage range. The voltage range determination circuit 100 maintains the second selection voltage Vs2 as the comparison voltage Vcom (Step S160) before the object voltage Vobj becomes greater than the second selection voltage Vs2 selected as the comparison voltage Vcom. The voltage range determination circuit 100 determines whether the object voltage Vobj becomes greater than the second selection voltage Vs2 selected as the comparison voltage Vcom (Step S170). The voltage range determination circuit 100 switches the comparison voltage Vcom from the second selection voltage Vs2 to the first selection voltage Vs1 (Step S180) at the time when the object voltage Vobj becomes greater than the second selection voltage Vs2 selected as the comparison voltage Vcom. The second selection voltage Vs2 is greater than the first selection voltage Vs1. Then, the voltage range determination circuit 100 determines the object voltage Vobj to be within the first object voltage range (Step S190). Thus, the input voltage Vin may be determined to be within the first input voltage range.

As described above, since the object voltage Vobj is much greater than the comparison voltage Vcom after the comparison voltage Vcom is switched from the second selection voltage Vs2 to the first selection voltage Vs1, the voltage range of the object voltage Vobj (i.e., the input voltage Vin) may be precisely determined even when the object voltage Vobj (i.e., the input voltage Vin) fluctuates due to external noise. In detail, as the input voltage Vin increases, the voltage range determination circuit 100 sets the first object voltage range to be from the second selection voltage Vs2 to the reference voltage Vref before the object voltage Vobj becomes greater than the second selection voltage Vs2 selected as the comparison voltage Vcom. Then, the voltage range determination circuit 100 sets the first object voltage range to be from the first selection voltage Vs1 to the reference voltage Vref after the object voltage Vobj becomes greater than the second selection voltage Vs2 selected as the comparison voltage Vcom. In addition, as the input voltage Vin increases, the voltage range determination circuit 100 sets the second object voltage range to be from the ground voltage GND to the second selection voltage Vs2 before the object voltage Vobj becomes greater than the second selection voltage Vs2 selected as the comparison voltage Vcom. Then, the voltage range determination circuit 100 sets the second object voltage range to be from the ground voltage GND to the first selection voltage Vs1 after the object voltage Vobj becomes greater than the second selection voltage Vs2 selected as the comparison voltage Vcom. That is, at the time when the object voltage Vobj becomes greater than the second selection voltage Vs2 selected as the comparison voltage Vcom as the input voltage Vin increases, the first object voltage range may become wider by the voltage range hysteresis period, and the second voltage range may become narrower by the voltage range hysteresis period.

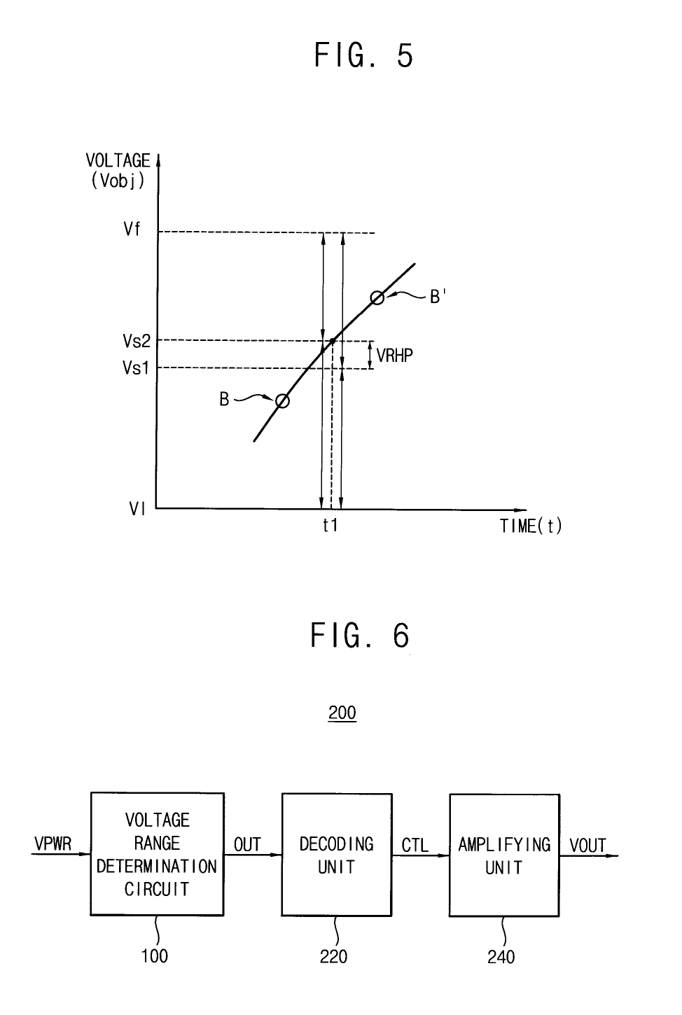

FIG. 5 is a graph illustrating operations of a voltage range determination circuit of FIG. 1 as an input voltage increases.

Referring to FIG. 5, the voltage range determination circuit 100 generates the object voltage Vobj by scaling down the input voltage Vin. Before the object voltage Vobj becomes greater than the second selection voltage Vs2 selected as the comparison voltage Vcom (i.e., when the object voltage Vobj has a first voltage level B), the first object voltage range is set to be from the second selection voltage Vs2 to a maximum voltage Vf (e.g., the reference voltage Vref), and the second object voltage range is set to be from a minimum voltage V1 (e.g., the ground voltage GND) to the second selection voltage Vs2. Thus, even when the input voltage Vin fluctuates due to external noise, the object voltage Vobj may be determined to be within the second object voltage range before the object voltage Vobj becomes greater than the second selection voltage Vs2 at a first time t1. Then, after the object voltage Vobj becomes greater than the second selection voltage Vs2 at the first time t1 (i.e., when the object voltage Vobj has a second voltage level B′), the first object voltage range is set to be from the first selection voltage Vs1 to the maximum voltage Vf (e.g., the reference voltage Vref), and the second voltage range is set to be from the minimum voltage V1 (e.g., the ground voltage GND) to the first selection voltage Vs1. Thus, even when the input voltage Vin fluctuates due to external noise, the object voltage Vobj may be determined to be within the first object voltage range after the object voltage Vobj becomes greater than the second selection voltage Vs2 at the first time t1.

Generally, as noise is input from outside, the input voltage Vin may fluctuate. Thus, the object voltage Vobj generated by scaling down the input voltage Vin may also fluctuate. As a result, the object voltage Vobj having the first voltage level B may be determined to be within the first object voltage range due to external noise near the first time t1 although the object voltage Vobj having the first voltage level B should be determined to be within the second object voltage range. Similarly, the object voltage Vobj having the second voltage level B′ may be determined to be within the second object voltage range due to external noise near the first time t1 although the object voltage Vobj having the second voltage level B′ should be determined to be within the first object voltage range. Thus, the voltage range determination circuit 100 sets the voltage range hysteresis period VRHP at the boundary of the divided object voltage ranges (e.g., the first object voltage range and the second object voltage range) such that the voltage range determination circuit 100 may precisely determine the object voltage Vobj having the first voltage level B to be within the second object voltage range, and the object voltage Vobj having the second voltage level B′ to be within the first object voltage range even when the object voltage Vobj fluctuates due to external noise. The voltage range hysteresis period VRHP may be controlled by adjusting the difference between the first selection voltage Vs1 and the second selection voltage Vs2. As described above, the voltage range of the input voltage Vin may be determined by scaling up the voltage range of the object voltage Vobj.

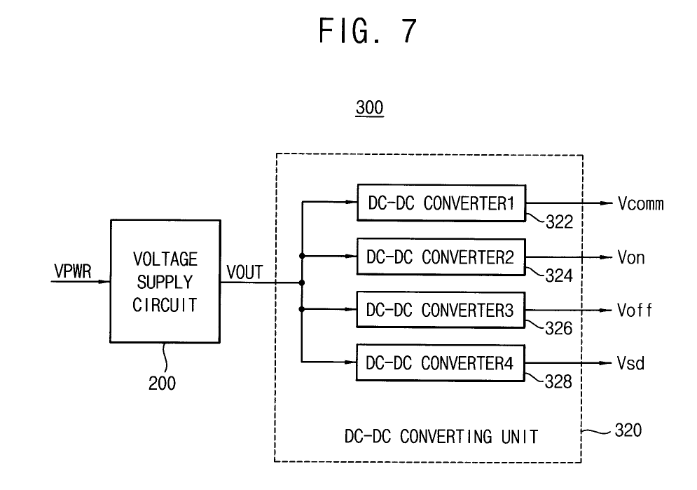

FIG. 6 is a block diagram illustrating a voltage supply circuit having a voltage range determination circuit of FIG. 1.

Referring to FIG. 6, the voltage supply circuit 200 may include the voltage range determination circuit 100, a decoding unit 220, and an amplifying unit 240.

The voltage range determination circuit 100 receives the input voltage Vin (e.g., a power voltage VPWR output from a battery) to generate the object voltage Vobj, and generates the output signal OUT corresponding to the voltage range of the object voltage Vobj. As the input voltage Vin fluctuates due to external noise, the object voltage Vobj may also fluctuate. In an exemplary embodiment, the voltage range determination circuit 100 may include the object voltage generating unit 120 that generates the object voltage Vobj by performing the voltage division on the input voltage Vin (e.g., the power voltage VPWR), the selection voltage generating unit 140 that generates the first selection voltage Vs1 and the second selection voltage Vs2 by performing the voltage division on the reference voltage Vref, the comparison voltage selecting unit 160 that selects one of the first selection voltage Vs1 and the second selection voltage Vs2 as the comparison voltage Vcom based on the output signal OUT, and the output signal generating unit 180 that compares the object voltage Vobj with the comparison voltage Vcom to generate the output signal OUT. Since the object voltage Vobj is a scaled down voltage of the input voltage Vin, the voltage range of the input voltage Vin may be determined by scaling up the voltage range of the object voltage Vobj.

The decoding unit 220 decodes the logic state of the output signal OUT to generate a voltage gain control signal CTL. In an exemplary embodiment, the decoding unit 220 may generate the voltage gain control signal CTL for decreasing the voltage gain of the amplifying unit 240 when the output signal OUT has the first logic state, and may generate the voltage gain control signal CTL for increasing the voltage gain of the amplifying unit 240 when the output signal OUT has the second logic state. For example, the output signal OUT having logic “HIGH” state may be generated when the object voltage Vobj is within the first object voltage range (i.e., a relatively high object voltage range). Then, the decoding unit 220 may generate the voltage gain control signal CTL for decreasing the voltage gain of the amplifying unit 240 by decoding the output signal OUT. On the other hand, the output signal OUT having logic “LOW” state may be generated when the object voltage Vobj is within the second object voltage range (i.e., a relatively low object voltage range). Then, the decoding unit 220 may generate the voltage gain control signal CTL for increasing the voltage gain of the amplifying unit 240 by decoding the output signal OUT.

The amplifying unit 240 changes the voltage gain based on the voltage gain control signal CTL output from the decoding unit 220. In an exemplary embodiment, the amplifying unit 240 may increase or decrease the voltage gain based on the voltage gain control signal CTL, and may amplify an internal voltage by the voltage gain to generate an output voltage VOUT. For example, the internal voltage may be the object voltage Vobj. In an exemplary embodiment, the amplifying unit 240 may change the voltage gain by changing at least one resistive value of variable resistors based on the voltage gain control signal CTL output from the decoding unit 220. For example, the voltage gain control signal CTL for decreasing the voltage gain of the amplifying unit 240 may be generated when the object voltage Vobj is within the first object voltage range (i.e., a relatively high object voltage range). On the other hand, the voltage gain control signal CTL for increasing the voltage gain may be generated when the object voltage Vobj is within the second object voltage range (i.e., a relatively low object voltage range).

As described above, the voltage range determination circuit 100 may precisely determine the voltage range of the input voltage Vin (e.g., the power voltage VPWR) by setting the divided object voltage ranges, by setting the voltage range hysteresis period at the boundary of the divided object voltage ranges, by determining the voltage range of the object voltage Vobj based on the divided object voltage ranges, and by scaling up the voltage range of the object voltage Vobj. As a result, the power supply circuit 200 may precisely determine the voltage range of the input voltage Vin (e.g., the power voltage VPWR) even when the input voltage Vin (e.g., the power voltage VPWR) fluctuates due to external noise, and may generate the output voltage VOUT that is substantially stable by changing the voltage gain of the amplifying unit 240 based on the voltage gain control signal CTL output from the decoding unit 220. For example, the power supply circuit 200 may decrease the voltage gain of the amplifying unit 240 when the object voltage Vobj is within the relatively high object voltage range, and may increase the voltage gain of the amplifying unit 240 when the object voltage Vobj is within the low relatively low object voltage range. Thus, the power supply circuit 200 substantially operates as a voltage regulator such that the power supply circuit 200 may be used to supply the stable voltage in a display device of an electric device.

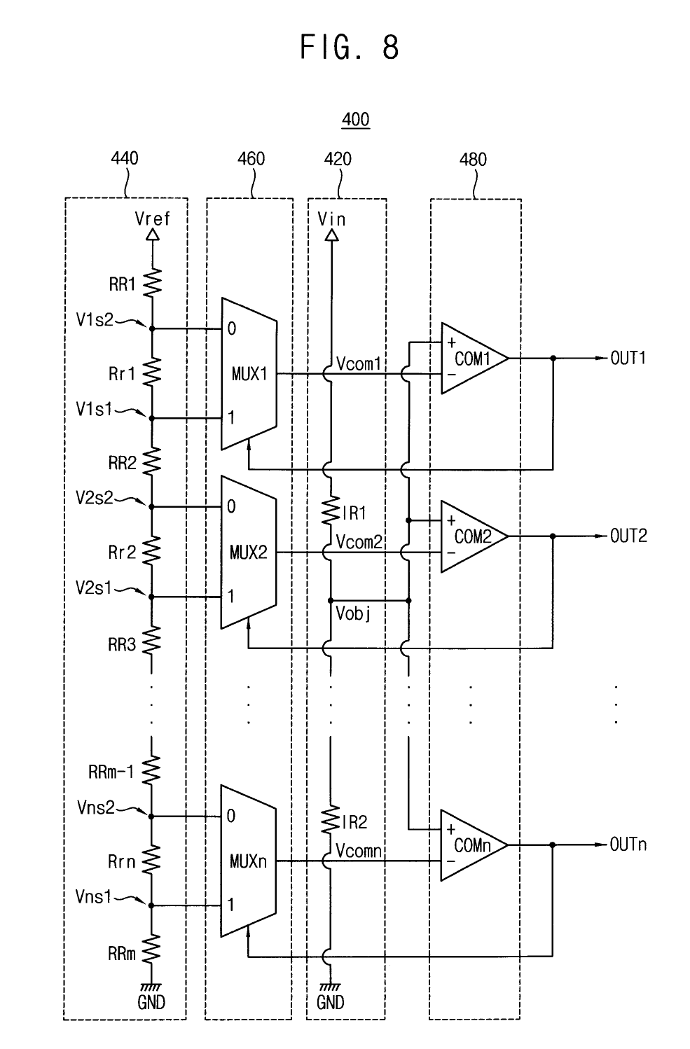

FIG. 7 is a block diagram illustrating a display driving voltage generator having a voltage supply circuit of FIG. 6.

Referring to FIG. 7, the display driving voltage generator 300 may include a voltage supply circuit 200 and a DC-DC converting unit 320.

The power supply circuit 200 receives the input voltage Vin (e.g., the power voltage VPWR), and supplies the output voltage VOUT that is substantially stable even when the input voltage Vin (e.g., the power voltage VPWR) fluctuates due to external noise. In an exemplary embodiment, the voltage supply circuit 200 may include the object voltage generating unit 120 that generates the object voltage Vobj by performing the voltage division on the input voltage Vin (e.g., the power voltage VPWR), the selection voltage generating unit 140 that generates the first selection voltage Vs1 and the second selection voltage Vs2 by performing the voltage division on the reference voltage Vref, the comparison voltage selecting unit 160 that selects one of the first selection voltage Vs1 and the second selection voltage Vs2 as the comparison voltage Vcom based on the output signal OUT, the output signal generating unit 180 that compares the object voltage Vobj with the comparison voltage Vcom to generate the output signal OUT, the decoding unit 220 that decodes the output signal OUT to generate the voltage gain control signal CTL, and the amplifying unit 240 that amplifies the internal voltage by the voltage gain to generate the output voltage VOUT.

The DC-DC converting unit 320 generates a plurality of display driving voltages (e.g., a gate-on voltage Von, a gate-off voltage Voff, a source driving voltage Vsd, and a common voltage Vcomm) based on the output voltage VOUT output from the voltage supply circuit 200. In an exemplary embodiment, the DC-DC converting unit 320 may include a first DC-DC converter 322 that generates the common voltage Vcomm based on the output voltage VOUT, a second DC-DC converter 324 that generates the gate-on voltage Von based on the output voltage VOUT, a third DC-DC converter 326 that generates the gate-off voltage Voff based on the output voltage VOUT, and a fourth DC-DC converter 328 that generates the source driving voltage Vsd based on the output voltage VOUT. As described above, the DC-DC converting unit 320 may output the display driving voltages generated by the first through fourth DC-DC converters 322, 324, 326, and 328.

Generally, an input DC voltage for the first through fourth DC-DC converters 322, 324, 326, and 328 should be within a certain range. Thus, the first through fourth DC-DC converters 322, 324, 326, and 328 may abnormally operate, or may be damaged when the input DC voltage is out of the certain range. Thus, the voltage supply circuit 200 may supply the output voltage VOUT that is substantially stable within the certain range to the first through fourth DC-DC converters 322, 324, 326, and 328 even when the input voltage Vin (e.g., the power voltage VPWR) fluctuates due to external noise. In detail, the voltage supply circuit 200 may change the voltage gain of the amplifying unit 240 based on the voltage range of the object voltage Vobj, and amplify the internal voltage by the voltage gain to generate the output voltage VOUT that is substantially stable within a certain range.

As a result, the display driving voltage generator 300 may achieve high operation reliability because the display driving voltage generator 300 successfully generates the display driving voltages (e.g., the gate-on voltage Von, the gate-off voltage Voff, the source driving voltage Vsd, and the common voltage Vcomm) even when the input voltage Vin (e.g., the power voltage VPWR) fluctuates due to external noise.

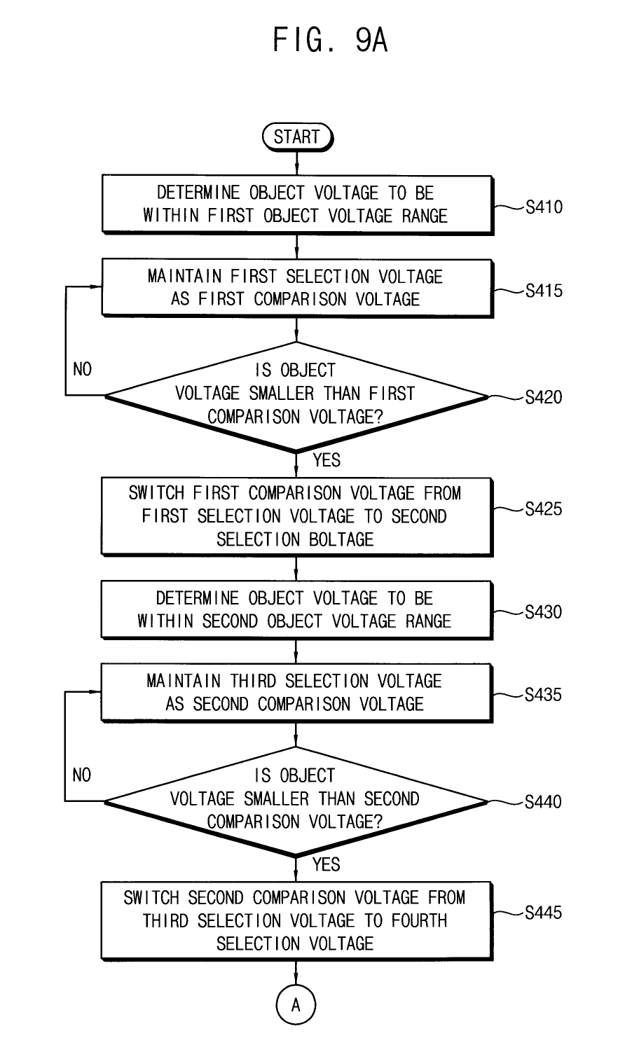

FIG. 8 is a block diagram illustrating a voltage range determination circuit according to some exemplary embodiments.

Referring to FIG. 8, the voltage range determination circuit 400 may include an object voltage generating unit 420, a selection voltage generating unit 440, a comparison voltage selecting unit 460, and an output signal generating unit 480.

The object voltage generating unit 420 generates an object voltage Vobj based on an input voltage Vin. The object voltage Vobj corresponds to a scaled-down voltage of the input voltage Vin. In an exemplary embodiment, the object voltage generating unit 420 performs a voltage division on the input voltage Vin using a plurality of resistors IR1 and IR2 such that the object voltage generating unit 420 may generate the object voltage Vobj. Generally, the input voltage Vin input to electric devices (e.g., a power voltage output from a battery) may be a relatively high when compared to a desired voltage range or may be outside of the desired voltage range for the electric devices. Thus, the object voltage generating unit 420 may scale down the input voltage Vin to generate the object voltage Vobj that is within the voltage range for use in the voltage range determination circuit 400. However, if the input voltage Vin is within the voltage range for use in the voltage range determination circuit 400, the object voltage generating unit 420 may not scale down the input voltage Vin. That is, the object voltage Vobj may be substantially the same as the input voltage Vin if the input voltage Vin is within the voltage range for use in the voltage range determination circuit 400. In an exemplary embodiment, the object voltage generating unit 420 may perform the voltage division on the input voltage Vin using variable resistive elements (e.g., variable resistors) instead of the resistors IR1 and IR2. In an exemplary embodiment, the object voltage generating unit 420 may perform the voltage division on the input voltage Vin using active elements (e.g., diodes) instead of the resistors IR1 and IR2.

The selection voltage generating unit 440 generates a first through nth selection voltage groups based on a reference voltage Vref. For example, the first selection voltage group may include a plurality of selection voltages V1s1 and V1s2, and the nth selection voltage group may include a plurality of selection voltages Vns1 and Vns2. In an exemplary embodiment, the selection voltage generating unit 440 performs a voltage division on the reference voltage Vref using a plurality of resistors RR1 through RRm, and Rr1 through Rrn such that the selection voltage generating unit 440 may generate the first through nth selection voltage groups. One of the selection voltages in each of the first through nth selection voltage groups is output as a first through nth comparison voltages Vcom1 through Vcomn, respectively. For example, one of the selection voltages V1s1 and V1s2 in the first selection voltage group may be output as the first comparison voltage Vcom1, and one of the selection voltages Vns1 and Vns2 in the nth selection voltage group may be output as the nth comparison voltage Vcomn. A plurality of divided object voltage ranges for determining a voltage range of the object voltage may include a first through (n+1)th object voltage ranges. That is, the first object voltage range is from the first comparison voltage Vcom1 to the reference voltage Vref, the second object voltage range is from the second comparison voltage Vcom2 to the first comparison voltage Vcom1, . . . , the nth object voltage range is from the nth comparison voltage Vcomn to the n−1(th) comparison voltage Vcomn−1, and the (n+1)th object voltage range is from a ground voltage GND to the nth comparison voltage Vcomn. Each difference between the selection voltages of the first through nth selection voltage groups corresponds to a first through nth voltage range hysteresis periods, respectively. The first through nth voltage range hysteresis periods are set at boundaries of the divided object voltage ranges (i.e., the first through (n+1)th object voltage range). Thus, the selection voltage generating unit 440 adjusts each difference between the selection voltages of the first through nth selection voltage groups to control the first through nth voltage range hysteresis periods, respectively. In an exemplary embodiment, the selection voltage generating unit 440 may perform the voltage division on the reference voltage Vref using variable resistive elements (e.g., variable resistors) instead of the resistors RR1 through RRm, and Rr1 through Rrn. In an exemplary embodiment, the selection voltage generating unit 140 may perform the voltage division on the input voltage Vref using active elements (e.g., diodes) instead of the resistors RR1 through RRm, and Rr1 through Rrn.

The comparison voltage selecting unit 460 selects one of the selection voltages as the first through nth comparison voltage Vcom1 through Vcomn for the first through nth selection voltage groups based on a first through nth output signal OUT1 through OUTn, respectively. For example, the comparison voltage selecting unit 460 may select one of the selection voltages V1s1 and V1s2 of the first selection voltage group as the first comparison voltage Vcom1 based on the first output signal OUT1, and the comparison voltage selecting unit 460 may select one of the selection voltages Vns1 and Vns2 of the nth selection voltage group as the nth comparison voltage Vcomn based on the nth output signal OUTn. The first through nth output signals OUT1 through OUTn are fed back from the output signal generating unit 480. In an exemplary embodiment, the comparison voltage selecting unit 460 may be implemented by a plurality of multiplexers that respectively output one of the selection voltages of the first through nth selection voltage group as the first through nth comparison voltages Vcom1 through Vcomn based on the first through nth output signals OUT1 through OUTn. For example, the comparison voltage selecting unit 460 may output one selection voltage (e.g., V1s1, . . . , Vns1) when the output signal (e.g., OUT1, . . . , OUTn) has a first logic state (e.g., logic “HIGH” state), and may output another selection voltage (e.g., V1s2, . . . , Vns2) when the output signal (e.g., OUT1, . . . , OUTn) has a second logic state (e.g., logic “LOW” state). That is, the comparison voltage selecting unit 460 may change the first through (n+1)th object voltage range by switching the first through nth comparison voltage Vcom1 through Vcomn between one selection voltage (e.g., V1s1, . . . , Vns1) and another selection voltage (e.g., V1s2, . . . , Vns2).

The output signal generating unit 480 compares the object voltage Vobj with the first through nth comparison voltages Vcom1 through Vcomn to generate the first through nth output signals OUT1 through OUTn corresponding to comparison results. In an exemplary embodiment, the output signal generating unit 480 may be implemented by a plurality of comparators that respectively compare the object voltage Vobj with the first through nth comparison voltages Vcom1 through Vcomn to generate the first through nth output signals OUT1 through OUTn. For example, the output signal generating unit 480 may generate the output signal (e.g., OUT1, . . . , OUTn) having the first logic state (e.g., logic “HIGH” state) when the object voltage Vobj is greater than the comparison voltage (e.g., Vcom1, . . . , Vcomn), and may generate the output signal (e.g., OUT1, . . . , OUTn) having the second logic state (e.g., logic “LOW” state) when the object voltage Vobj is smaller than the comparison voltage (e.g., Vcom1, . . . , Vcomn). Here, the voltage range of the object voltage Vobj may be determined based on the logic states of the first through nth output signal OUT1 through OUTn. For example, assuming that the integer n is 2, the object voltage Vobj may be determined to be within the first object voltage range when the logic states of the first and second output signals OUT1 and OUT2 are “HIGH” and “HIGH”, may be determined to be within the second object voltage range when the logic states of the first and second output signals OUT1 and OUT2 are “LOW” and “HIGH”, and may be determined to be within the third object voltage range when the logic states of the first and second output signals OUT1 and OUT2 are “LOW” and “LOW”. That is, the output signal generating unit 480 may indicate that the object voltage Vobj is within the first object voltage range by outputting the first output signal OUT1 having the first logic state (e.g., logic “HIGH” state) and the second output signal OUT2 having the first logic state (e.g., logic “HIGH” state). The output signal generating unit 480 may indicate that the object voltage Vobj is within the second object voltage range by outputting the first output signal OUT1 having the second logic state (e.g., logic “LOW” state) and the second output signal OUT2 having the first logic state (e.g., logic “HIGH” state). The output signal generating unit 480 may indicate that the object voltage Vobj is within the third object voltage range by outputting the first output signal OUT1 having the second logic state (e.g., logic “LOW” state) and the second output signal OUT2 having the second logic state (e.g., logic “LOW” state).

Further, a voltage range of the input voltage Vin may be determined by scaling up the voltage range of the object voltage Vobj because the object voltage Vobj is generated by scaling down the input voltage Vin. A plurality of divided input voltage ranges for determining the voltage range of the input voltage Vin may include a first through (n+1)th input voltage ranges. The first through (n+1)th input voltage ranges are determined by scaling up the first through (n+1)th object voltage ranges, respectively. For example, the input voltage Vin may be determined to be within the first input voltage range when the object voltage Vobj is determined to be within the first object voltage range, the input voltage Vin may be determined to be within the second input voltage range when the object voltage Vobj is determined to be within the second object voltage range, . . . , the input voltage Vin may be determined to be within the nth input voltage range when the object voltage Vobj is determined to be within the nth object voltage range, and the input voltage Vin may be determined to be within the (n+1)th input voltage range when the object voltage Vobj is determined to be within the (n+1)th object voltage range. Thus, even when the input voltage Vin fluctuates due to external noise, the voltage range determination circuit 400 may precisely determine the voltage range of the input voltage Vin by setting the divided object voltage ranges, by setting the voltage range hysteresis periods at the boundaries of the divided object voltage ranges, by determining the voltage range of the object voltage Vobj based on the divided object voltage ranges, and by scaling up the voltage range of the object voltage Vobj.

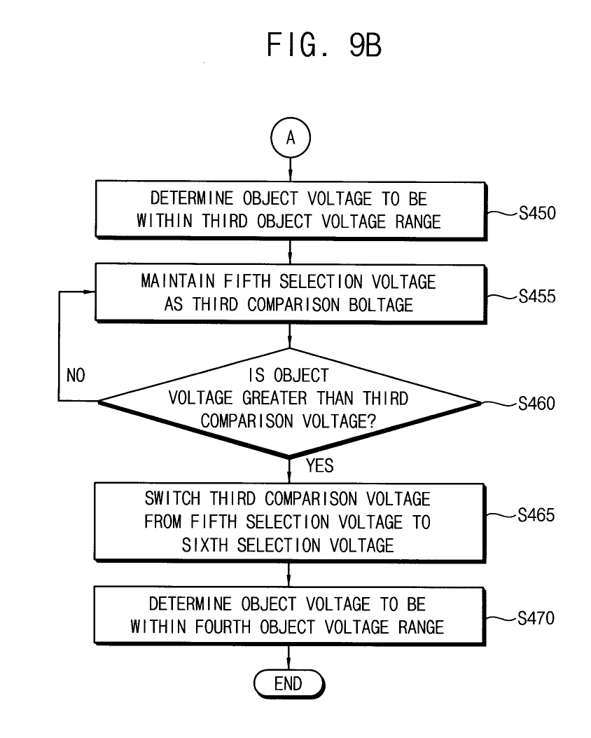

FIGS. 9A and 9B are flow charts illustrating operations of a voltage range determination circuit of FIG. 8 as an input voltage decreases.

Referring to FIGS. 9A and 9B, as the input voltage Vin decreases, the voltage range determination circuit 400 determines the object voltage Vobj to be within the first object voltage range (Step S410) when the object voltage Vobj becomes greater than the first selection voltage V1s1 selected as the first comparison voltage Vcom1. Thus, the input voltage Vin may be determined to be within the first input voltage range. The voltage range determination circuit 400 maintains the first selection voltage V1s1 as the first comparison voltage Vcom1 (Step S415) before the object voltage Vobj becomes smaller than the first selection voltage V1s1 selected as the first comparison voltage Vcom1. The voltage range determination circuit 400 determines whether the object voltage Vobj is smaller than the first selection voltage V1s1 selected as the first comparison voltage Vcom1 (Step S420). The voltage range determination circuit 400 switches the first comparison voltage Vcom1 from the first selection voltage V1s1 to the second selection voltage V1s2 (Step S425) at the time when the object voltage Vobj becomes smaller than the first selection voltage V1s1 selected as the first comparison voltage Vcom1. The second selection voltage V1s2 is greater than the first selection voltage V1s1. Then, the voltage range determination circuit 400 determines the object voltage Vobj to be within the second object voltage range (Step S430). Thus, the input voltage Vin may be determined to be within the second input voltage range. As described above, since the object voltage Vobj is much smaller than the first comparison voltage Vcom1 after the first comparison voltage Vcom1 is switched from the first selection voltage V1s1 to the second selection voltage V1s2, the voltage range of the object voltage Vobj (i.e., the input voltage Vin) may be precisely determined even when the object voltage Vobj (i.e., the input voltage Vin) fluctuates due to external noise.

As the input voltage Vin further decreases, the voltage range determination circuit 400 maintains the third selection voltage V2s1 as the second comparison voltage Vcom2 (Step S435) before the object voltage Vobj becomes smaller than the third selection voltage V2s1 selected as the second comparison voltage Vcom2. The voltage range determination circuit 400 determines whether the object voltage Vobj becomes smaller than the third selection voltage V2s1 selected as the second comparison voltage Vcom2 (Step S440). The voltage range determination circuit 400 switches the second comparison voltage Vcom2 from the third selection voltage V2s1 to the fourth selection voltage V2s2 (Step S445) at the time when the object voltage Vobj becomes smaller than the third selection voltage V2s1 selected as the second comparison voltage Vcom2. The fourth selection voltage V2s2 is greater than the third selection voltage V2s1. Then, the voltage range determination circuit 400 determines the object voltage Vobj to be within the third object voltage range (Step S450). Thus, the input voltage Vin may be determined to be within the third input voltage range. As described above, since the object voltage Vobj is much smaller than the second comparison voltage Vcom2 after the second comparison voltage Vcom2 is switched from the third selection voltage V2s1 to the fourth selection voltage V2s2, the voltage range of the object voltage Vobj (i.e., the input voltage Vin) may be precisely determined even when the object voltage Vobj (i.e., the input voltage Vin) fluctuates due to external noise.

As the input voltage Vin further decreases, the voltage range determination circuit 400 maintains the fifth selection voltage V3s1 as the third comparison voltage Vcom3 (Step S455) before the object voltage Vobj becomes smaller than the fifth selection voltage V3s1 selected as the third comparison voltage Vcom3. The voltage range determination circuit 400 determines whether the object voltage Vobj becomes smaller than the fifth selection voltage V3s1 selected as the third comparison voltage Vcom3 (Step S460). The voltage range determination circuit 400 switches the third comparison voltage Vcom3 from the fifth selection voltage V3s1 to the sixth selection voltage V3s2 (Step S465) at the time when the object voltage Vobj becomes smaller than the fifth selection voltage V3s1 selected as the third comparison voltage Vcom3. The sixth selection voltage V3s2 is greater than the fifth selection voltage V3s1. Then, the voltage range determination circuit 400 determines the object voltage Vobj to be within the fourth object voltage range (Step S470). Thus, the input voltage Vin may be determined to be within the fourth input voltage range. As described above, since the object voltage Vobj is much smaller than the third comparison voltage Vcom3 after the third comparison voltage Vcom3 is switched from the fifth selection voltage V3s1 to the sixth selection voltage V3s2, the voltage range of the object voltage Vobj (i.e., the input voltage Vin) may be precisely determined even when the object voltage Vobj (i.e., the input voltage Vin) fluctuates due to external noise.

The voltage range determination circuit 400 may precisely determine the voltage range of the input voltage Vin by setting the divided object voltage ranges (i.e., the first through fourth object voltage range), by setting the first through third voltage range hysteresis period VRHP1 through VRHP3 at the boundaries of the divided object voltage ranges, by determining the voltage range of the object voltage Vobj based on the divided object voltage ranges, and by scaling up the voltage range of the object voltage Vobj. For example, the first voltage range hysteresis period VRHP1 may be placed between the first object voltage range and the second object voltage range, the second voltage range hysteresis period VRHP2 may be placed between the second object voltage range and the third object voltage range, and the third voltage range hysteresis period VRHP3 may be placed between the third object voltage range and the fourth object voltage range. In addition, the first voltage range hysteresis period VRHP1 may correspond to a difference between the first selection voltage V1s1 and the second selection voltage V1s2, the second voltage range hysteresis period VRHP2 may correspond to a difference between the third selection voltage V2s1 and the fourth selection voltage V2s2, and the third voltage range hysteresis period VRHP3 may correspond to a difference between the fifth selection voltage V3s1 and the sixth selection voltage V3s2.

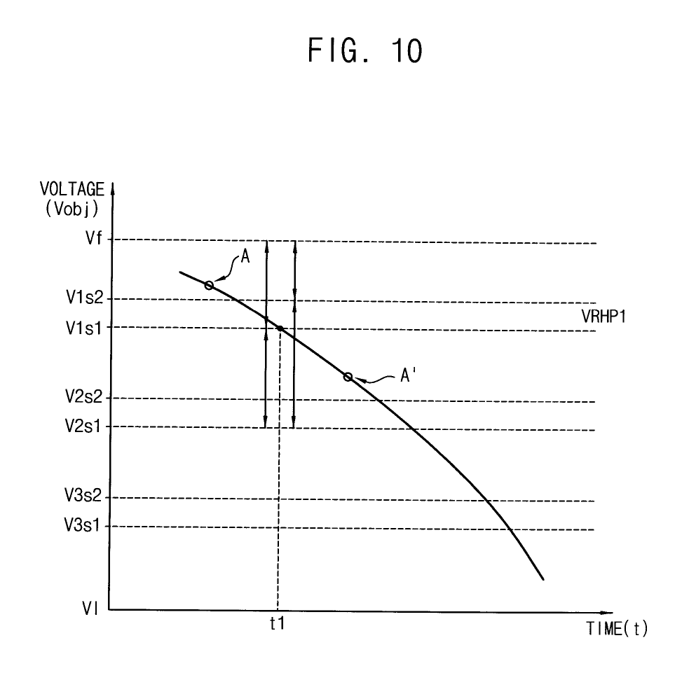

FIG. 10 is a first graph illustrating operations of a voltage range determination circuit of FIG. 8 as an input voltage decreases.

Referring to FIG. 10, the voltage range determination circuit 400 generates the object voltage Vobj by scaling down the input voltage Vin. Before the object voltage Vobj becomes smaller than the first selection voltage V1s1 selected as the first comparison voltage Vcom1 (i.e., when the object voltage Vobj has a first voltage level A), the first object voltage range is set to be from the first selection voltage V1s1 to a maximum voltage Vf (e.g., the reference voltage Vref), and the second object voltage range is set to be from a third selection voltage V2s1 to the first selection voltage V1s1. Thus, even when the input voltage Vin fluctuates due to external noise, the object voltage Vobj may be determined to be within the first object voltage range before the object voltage Vobj becomes smaller than the first selection voltage V1s1 at a first time t1. Then, after the object voltage Vobj becomes smaller than the first selection voltage V1s1 at the first time t1 (i.e., when the object voltage Vobj has a second voltage level A′), the first object voltage range is set to be from the second selection voltage V1s2 to the maximum voltage Vf (e.g., the reference voltage Vref), and the second object voltage range is set to be from the third selection voltage V2s1 to the second selection voltage V1s2. Thus, even when the input voltage Vin fluctuates due to external noise, the object voltage Vobj may be determined to be within the second object voltage range after the object voltage Vobj becomes smaller than the first selection voltage V1s1 at the first time t1. The first voltage range hysteresis period VRHP1 corresponds to a difference between the first selection voltage V1s1 and the second selection voltage V1s2. As described above, the voltage range of the input voltage Vin may be determined by scaling up the voltage range of the object voltage Vobj.

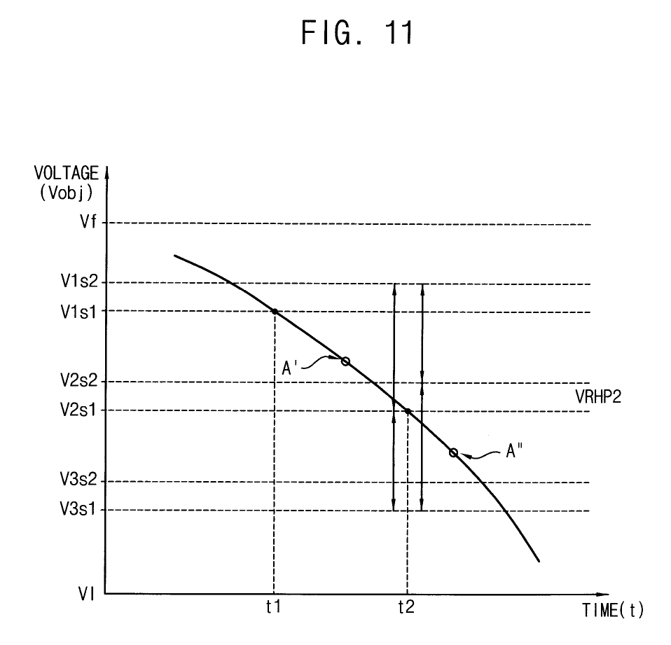

FIG. 11 is a second graph illustrating operations of a voltage range determination circuit of FIG. 8 as an input voltage decreases.

Referring to FIG. 11, the voltage range determination circuit 400 generates the object voltage Vobj by scaling down the input voltage Vin. Before the object voltage Vobj becomes smaller than the third selection voltage V2s1 selected as the second comparison voltage Vcom2 (i.e., when the object voltage Vobj has the second voltage level A′), the second object voltage range is set to be from the third selection voltage V2s1 to the second selection voltage V1s2, and the third object voltage range is set to be from a fifth selection voltage V3s1 to the third selection voltage V2s1. Thus, even when the input voltage Vin fluctuates due to external noise, the object voltage Vobj may be determined to be within the second object voltage range before the object voltage Vobj becomes smaller than the third selection voltage V2s1 at a second time t2. Then, after the object voltage Vobj becomes smaller than the third selection voltage V2s1 at the second time t2 (i.e., when the object voltage Vobj has a third voltage level A″), the second object voltage range is set to be from a fourth selection voltage V2s2 to the second selection voltage V1s2, and the third object voltage range is set to be from the fifth selection voltage V3s1 to the fourth selection voltage V2s2. Thus, even when the input voltage Vin fluctuates due to external noise, the object voltage Vobj may be determined to be within the third object voltage range after the object voltage Vobj becomes smaller than the third selection voltage V2s1 at the second time t2. The second voltage range hysteresis period VRHP2 corresponds to a difference between the third selection voltage V2s1 and the fourth selection voltage V2s2. As described above, the voltage range of the input voltage Vin may be determined by scaling up the voltage range of the object voltage Vobj.

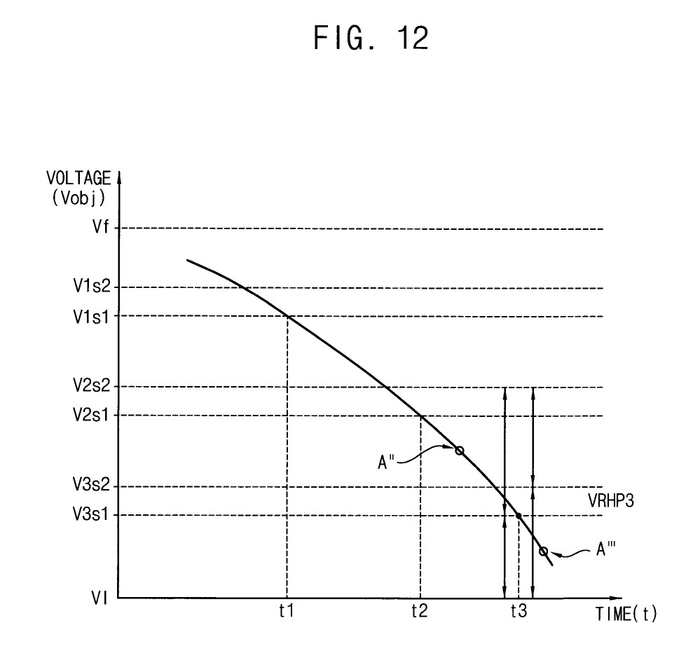

FIG. 12 is a third graph illustrating operations of a voltage range determination circuit of FIG. 8 as an input voltage decreases.

Referring to FIG. 12, the voltage range determination circuit 400 generates the object voltage Vobj by scaling down the input voltage Vin. Before the object voltage Vobj becomes smaller than the fifth selection voltage V3s1 selected as the third comparison voltage Vcom3 (i.e., when the object voltage Vobj has the third voltage level A″), the third object voltage range is set to be from the a fifth selection voltage V3s1 to the fourth selection voltage V2s2, and the fourth object voltage range is set to be from a minimum voltage V1 (e.g., the ground voltage GND) to the fifth selection voltage V3s1. Thus, even when the input voltage Vin fluctuates due to external noise, the object voltage Vobj may be determined to be within the third object voltage range before the object voltage Vobj becomes smaller than the fifth selection voltage V3s1 at a third time t3. Then, after the object voltage Vobj becomes smaller than the fifth selection voltage V3s1 at the third time t3 (i.e., when the object voltage Vobj has a fourth voltage level A′″), the third object voltage range is set to be from a sixth selection voltage V3s2 to the fourth selection voltage V2S2, and the fourth object voltage range is set to be from the minimum voltage (e.g., the ground voltage GND) to the sixth selection voltage V3s2. Thus, even when the input voltage Vin fluctuates due to external noise, the object voltage Vobj may be determined to be within the fourth object voltage range after the object voltage Vobj becomes smaller than the fifth selection voltage V3s1 at the third time t3. The third voltage range hysteresis period VRHP3 corresponds to a difference between the fifth selection voltage V3s1 and the sixth selection voltage V3s2. As described above, the voltage range of the input voltage Vin may be determined by scaling up the voltage range of the object voltage Vobj.

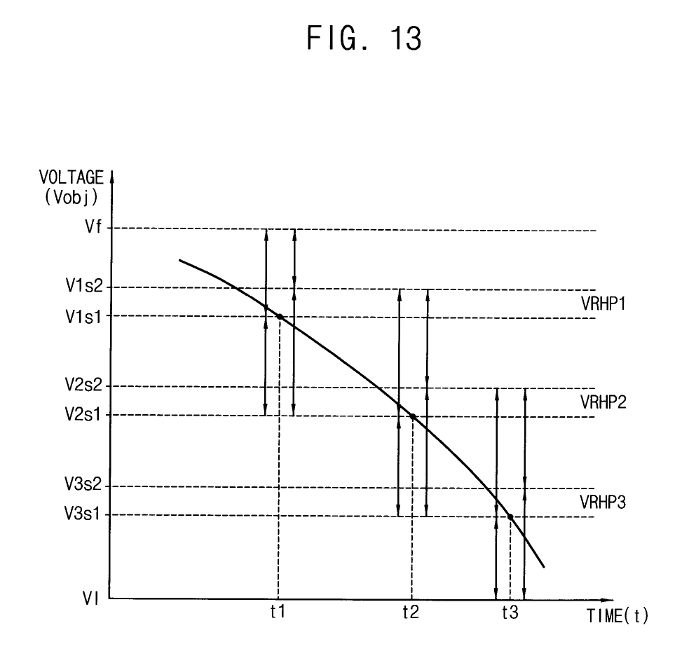

FIG. 13 is a graph illustrating a first through fourth object voltage range changed by a voltage range determination circuit of FIG. 8 as an input voltage decreases.

Referring to FIG. 13, the voltage range determination circuit 400 sets the first voltage range hysteresis period VRHP1 at the boundary of the divided object voltage ranges (e.g., the first object voltage range and the second object voltage range) such that the voltage range determination circuit 400 may precisely determine the object voltage Vobj having the first voltage level A to be within the first object voltage range, and the object voltage Vobj having the second voltage level A′ to be within the second object voltage range even when the object voltage Vobj fluctuates due to external noise. In addition, the voltage range determination circuit 400 sets the second voltage range hysteresis period VRHP2 at the boundary of the divided object voltage ranges (e.g., the second object voltage range and the third object voltage range) such that the voltage range determination circuit 400 may precisely determine the object voltage Vobj having the second voltage level A′ to be within the second object voltage range, and the object voltage Vobj having the third voltage level A″ to be within the third object voltage range even when the object voltage Vobj fluctuates due to external noise. Further, the voltage range determination circuit 400 sets the third voltage range hysteresis period VRHP3 at the boundary of the divided object voltage ranges (e.g., the third object voltage range and the fourth object voltage range) such that the voltage range determination circuit 400 may precisely determine the object voltage Vobj having the third voltage level A″ to be within the third object voltage range, and the object voltage Vobj having the fourth voltage level A′″ to be within the fourth object voltage range even when the object voltage Vobj fluctuates due to external noise. As described above, the first voltage range hysteresis period VRHP1 may be controlled by adjusting the difference between the first selection voltage V1s1 and the second selection voltage V1s2, the second voltage range hysteresis period VRHP2 may be controlled by adjusting the difference between the third selection voltage V2s1 and the fourth selection voltage V2s2, and the third voltage range hysteresis period VRHP3 may be controlled by adjusting the difference between the fifth selection voltage V3s1 and the sixth selection voltage V3s2.

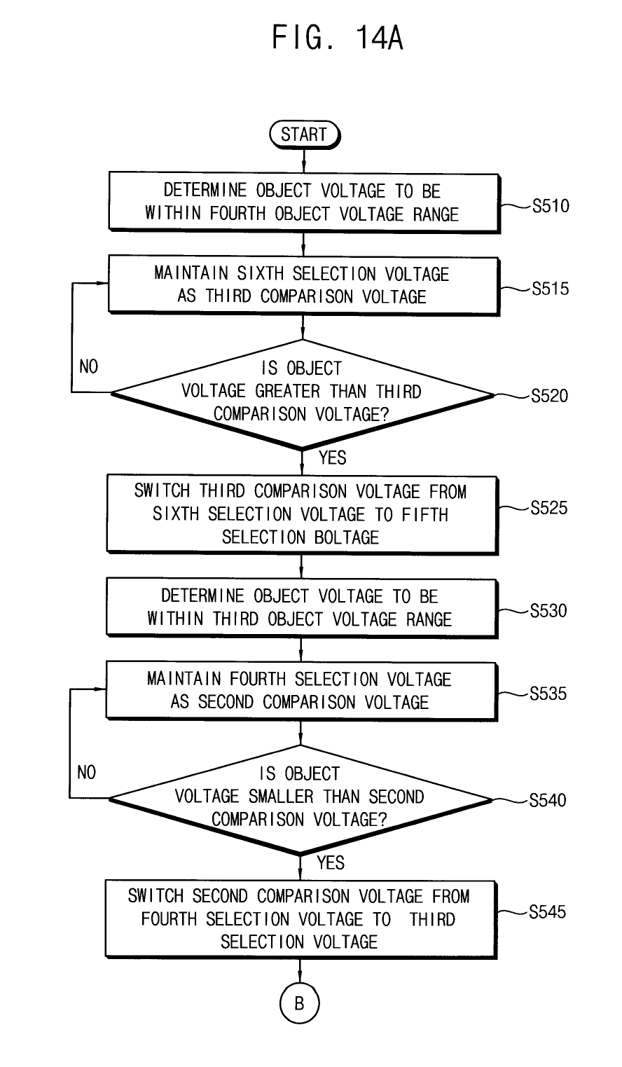

FIGS. 14A and 14B are flow charts illustrating operations of a voltage range determination circuit of FIG. 8 as an input voltage increases.

Referring to FIGS. 14A and 14B, as the input voltage Vin increases, the voltage range determination circuit 400 determines the object voltage Vobj to be within the fourth object voltage range (Step S510) when the object voltage Vobj becomes smaller than the sixth selection voltage V3s2 selected as the third comparison voltage Vcom3. Thus, the input voltage Vin may be determined to be within the fourth input voltage range. The voltage range determination circuit 400 maintains the sixth selection voltage V3s2 as the third comparison voltage Vcom3 (Step S510) before the object voltage Vobj becomes greater than the sixth selection voltage V3s2 selected as the third comparison voltage Vcom3. The voltage range determination circuit 400 determines whether the object voltage Vobj becomes greater than the sixth selection voltage V3s2 selected as the third comparison voltage Vcom3 (Step S520). The voltage range determination circuit 400 switches the third comparison voltage Vcom3 from the sixth selection voltage V3s2 to the fifth selection voltage V3s1 (Step S525) at the time when the object voltage Vobj becomes greater than the sixth selection voltage V3s2 selected as the third comparison voltage Vcom3. The sixth selection voltage V3s2 is greater than the fifth selection voltage V3s1. Then, the voltage range determination circuit 400 determines the object voltage Vobj to be within the third object voltage range (Step S530). Thus, the input voltage Vin may be determined to be within the third input voltage range. As described above, since the object voltage Vobj is much greater than the third comparison voltage Vcom3 after the third comparison voltage Vcom3 is switched from the sixth selection voltage V3s2 to the fifth selection voltage V3s1, the voltage range of the object voltage Vobj (i.e., the input voltage Vin) may be precisely determined even when the object voltage Vobj (i.e., the input voltage Vin) fluctuates due to external noise.

As the input voltage Vin further increases, the voltage range determination circuit 400 maintains the fourth selection voltage V2s2 as the second comparison voltage Vcom2 (Step S535) before the object voltage Vobj becomes greater than the fourth selection voltage V2s2 selected as the second comparison voltage Vcom2. The voltage range determination circuit 400 determines whether the object voltage Vobj becomes greater than the fourth selection voltage V2s2 selected as the second comparison voltage Vcom2 (Step S540). The voltage range determination circuit 400 switches the second comparison voltage Vcom2 from the fourth selection voltage V2s2 to the third selection voltage V2s1 (Step S545) at the time when the object voltage Vobj becomes greater than the fourth selection voltage V2s2 selected as the second comparison voltage Vcom2. The fourth selection voltage V2s2 is greater than the third selection voltage V2s1. Then, the voltage range determination circuit 400 determines the object voltage Vobj to be within the second object voltage range (Step S550). Thus, the input voltage Vin may be determined to be within the second input voltage range. As described above, since the object voltage Vobj is much greater than the second comparison voltage Vcom2 after the second comparison voltage Vcom2 is switched from the fourth selection voltage V2s2 to the third selection voltage V2s1, the voltage range of the object voltage Vobj (i.e., the input voltage Vin) may be precisely determined even when the object voltage Vobj (i.e., the input voltage Vin) fluctuates due to external noise.

As the input voltage Vin further increases, the voltage range determination circuit 400 maintains the second selection voltage V1s2 as the first comparison voltage Vcom1 (Step S555) before the object voltage Vobj becomes greater than the second selection voltage V1s2 selected as the first comparison voltage Vcom1. The voltage range determination circuit 400 determines whether the object voltage Vobj becomes greater than the second selection voltage V1s2 selected as the first comparison voltage Vcom1 (Step S560). The voltage range determination circuit 400 switches the first comparison voltage Vcom1 from the second selection voltage V1s2 to the first selection voltage V1s1 (Step S565) at the time when the object voltage Vobj becomes greater than the second selection voltage V1s2 selected as the first comparison voltage Vcom1. The second selection voltage V1s2 is greater than the first selection voltage V1s1. Then, the voltage range determination circuit 400 determines the object voltage Vobj to be within the first object voltage range (Step S570). Thus, the input voltage Vin may be determined to be within the first input voltage range. As described above, since the object voltage Vobj is much greater than the first comparison voltage Vcom1 after the first comparison voltage Vcom1 is switched from the second selection voltage V1s2 to the first selection voltage V1s1, the voltage range of the object voltage Vobj (i.e., the input voltage Vin) may be precisely determined even when the object voltage Vobj (i.e., the input voltage Vin) fluctuates due to external noise.

The voltage range determination circuit 400 may precisely determine the voltage range of the input voltage Vin by setting the divided object voltage ranges (i.e., the first through fourth object voltage range), by setting the first through third voltage range hysteresis period VRHP1 through VRHP3 at the boundaries of the divided object voltage ranges, by determining the voltage range of the object voltage Vobj based on the divided object voltage ranges, and by scaling up the voltage range of the object voltage Vobj. For example, the first voltage range hysteresis period VRHP1 may be placed between the first object voltage range and the second object voltage range, the second voltage range hysteresis period VRHP2 may be placed between the second object voltage range and the third object voltage range, and the third voltage range hysteresis period VRHP3 may be placed between the third object voltage range and the fourth object voltage range. In addition, the first voltage range hysteresis period VRHP1 may correspond to a difference between the first selection voltage V1s1 and the second selection voltage V1s2, the second voltage range hysteresis period VRHP2 may correspond to a difference between the third selection voltage V2s1 and the fourth selection voltage V2s2, and the third voltage range hysteresis period VRHP3 may correspond to a difference between the fifth selection voltage V3s1 and the sixth selection voltage V3s2.

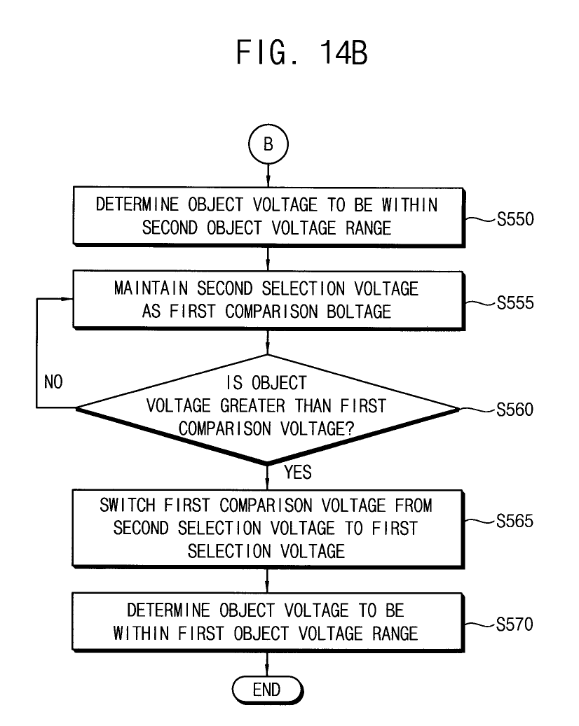

FIG. 15 is a first graph illustrating operations of a voltage range determination circuit of FIG. 8 as an input voltage increases.

Referring to FIG. 15, the voltage range determination circuit 400 generates the object voltage Vobj by scaling down the input voltage Vin. Before the object voltage Vobj becomes greater than the sixth selection voltage V3s2 selected as the third comparison voltage Vcom3 (i.e., when the object voltage Vobj has a first voltage level B), the third object voltage range is set to be from the sixth selection voltage V3s2 to the fourth selection voltage V2s2, and the fourth object voltage range is set to be from a minimum voltage (e.g., the ground voltage GND) to the sixth selection voltage V3s2. Thus, even when the input voltage Vin fluctuates due to external noise, the object voltage Vobj may be determined to be within the fourth object voltage range before the object voltage Vobj becomes greater than the sixth selection voltage V3s2 at a first time t1. Then, after the object voltage Vobj becomes greater than the sixth selection voltage V3s2 at the first time t1 (i.e., when the object voltage Vobj has a second voltage level B′), the third object voltage range is set to be from the fifth selection voltage V3s1 to the fourth selection voltage V2s2, and the fourth object voltage range is set to be from the minimum voltage (e.g., the ground voltage GND) to the fifth selection voltage V3s1. Thus, even when the input voltage Vin fluctuates due to external noise, the object voltage Vobj may be determined to be within the third object voltage range after the object voltage Vobj becomes greater than the sixth selection voltage V3s2 at the first time t1. The third voltage range hysteresis period VRHP3 corresponds to a difference between the fifth selection voltage V3s1 and the sixth selection voltage V3s2. As described above, the voltage range of the input voltage Vin may be determined by scaling up the voltage range of the object voltage Vobj.

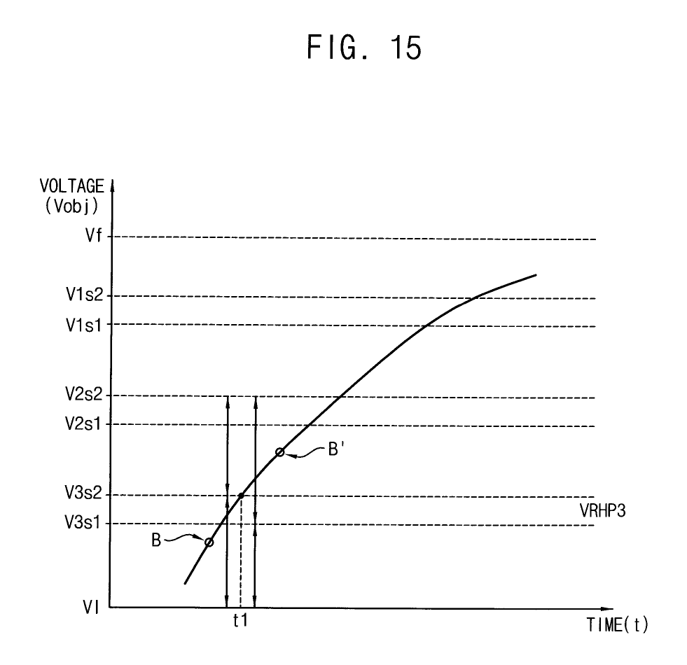

FIG. 16 is a second graph illustrating operations of a voltage range determination circuit of FIG. 8 as an input voltage increases.

Referring to FIG. 16, the voltage range determination circuit 400 generates the object voltage Vobj by scaling down the input voltage Vin. Before the object voltage Vobj becomes greater than the fourth selection voltage V2s2 selected as the second comparison voltage Vcom2 (i.e., when the object voltage Vobj has the second voltage level B′), the second object voltage range is set to be from the fourth selection voltage V2s2 to the second selection voltage V1s2, and the third object voltage range is set to be from a fifth selection voltage V3s1 to the fourth selection voltage V2s2. Thus, even when the input voltage Vin fluctuates due to external noise, the object voltage Vobj may be determined to be within the third object voltage range before the object voltage Vobj becomes greater than the fourth selection voltage V2s2 at a second time t2. Then, after the object voltage Vobj becomes greater than the fourth selection voltage V2s2 at the second time t2 (i.e., when the object voltage Vobj has a third voltage level B″), the second object voltage range is set to be from a third selection voltage V2s1 to the second selection voltage V1s2, and the third object voltage range is set to be from the fifth selection voltage V3s1 to the third selection voltage V2s1. Thus, even when the input voltage Vin fluctuates due to external noise, the object voltage Vobj may be determined to be within the second object voltage range after the object voltage Vobj becomes greater than the fourth selection voltage V2s2 at the second time t2. The second voltage range hysteresis period VRHP2 corresponds to a difference between the third selection voltage V2s1 and the fourth selection voltage V2s2. As described above, the voltage range of the input voltage Vin may be determined by scaling up the voltage range of the object voltage Vobj.

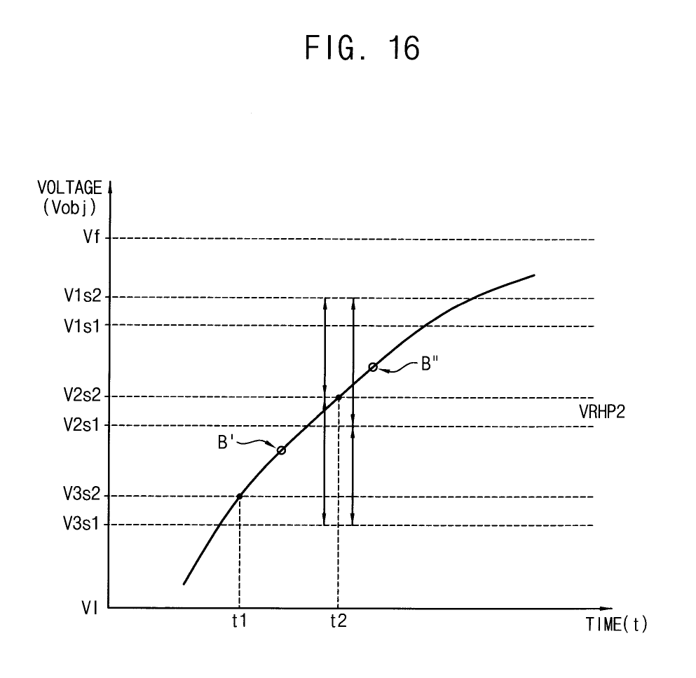

FIG. 17 is a third graph illustrating operations of a voltage range determination circuit of FIG. 8 as an input voltage increases.

Referring to FIG. 17, the voltage range determination circuit 400 generates the object voltage Vobj by scaling down the input voltage Vin. Before the object voltage Vobj becomes greater than the second selection voltage V1s2 selected as the first comparison voltage Vcom1 (i.e., when the object voltage Vobj has the third voltage level B″), the first object voltage range is set to be from the a second selection voltage V1s2 to a maximum voltage Vf (e.g., the reference voltage Vref), and the second object voltage range is set to be from the third selection voltage V2s1 to the second selection voltage V1s2. Thus, even when the input voltage Vin fluctuates due to external noise, the object voltage Vobj may be determined to be within the second object voltage range before the object voltage Vobj becomes greater than the second selection voltage V1s2 at a third time t3. Then, after the object voltage Vobj becomes greater than the second selection voltage V1s2 at the third time t3 (i.e., when the object voltage Vobj has a fourth voltage level B″), the first object voltage range is set to be from a first selection voltage V1s1 to the maximum voltage Vf (e.g., the reference voltage Vref), and the second object voltage range is set to be from the third selection voltage V2s1 to the first selection voltage V1s1. Thus, even when the input voltage Vin fluctuates due to external noise, the object voltage Vobj may be determined to be within the first object voltage range after the object voltage Vobj becomes greater than the second selection voltage V1s2 at the third time t3. The first voltage range hysteresis period VRHP1 corresponds to a difference between the first selection voltage V1s1 and the second selection voltage V1s2. As described above, the voltage range of the input voltage Vin may be determined by scaling up the voltage range of the object voltage Vobj.

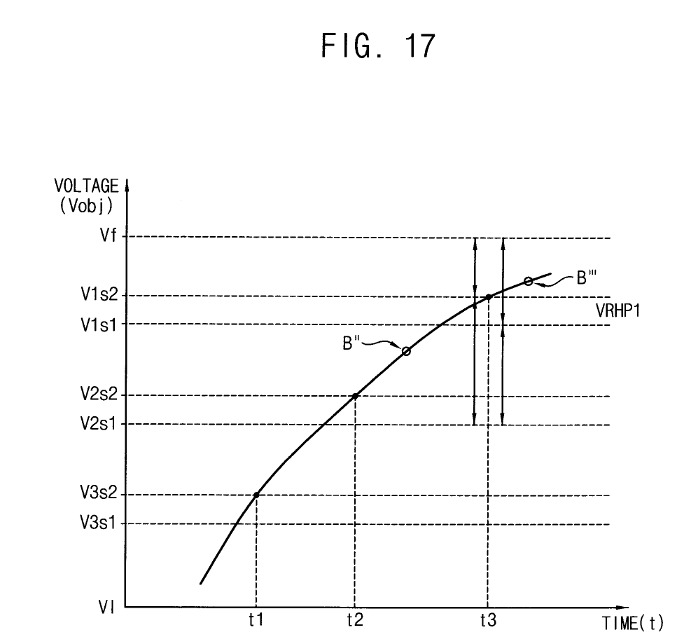

FIG. 18 is a graph illustrating a first through fourth object voltage range changed by a voltage range determination circuit of FIG. 8 as an input voltage increases.

Referring to FIG. 18, the voltage range determination circuit 400 sets the first voltage range hysteresis period VRHP1 at the boundary of the divided object voltage ranges (e.g., the first object voltage range and the second object voltage range) such that the voltage range determination circuit 400 may precisely determine the object voltage Vobj having the fourth voltage level B′″ to be within the first object voltage range, and the object voltage Vobj having the third voltage level B″ to be within the second object voltage range even when the object voltage Vobj fluctuates due to external noise. In addition, the voltage range determination circuit 400 sets the second voltage range hysteresis period VRHP2 at the boundary of the divided object voltage ranges (e.g., the second object voltage range and the third object voltage range) such that the voltage range determination circuit 400 may precisely determine the object voltage Vobj having the third voltage level B″ to be within the second object voltage range, and the object voltage Vobj having the second voltage level B′ to be within the third object voltage range even when the object voltage Vobj fluctuates due to external noise. Further, the voltage range determination circuit 400 sets the third voltage range hysteresis period VRHP3 at the boundary of the divided object voltage ranges (e.g., the third object voltage range and the fourth object voltage range) such that the voltage range determination circuit 400 may precisely determine the object voltage Vobj having the second voltage level B′ to be within the second object voltage range, and the object voltage Vobj having the first voltage level B to be within the first object voltage range even when the object voltage Vobj fluctuates due to external noise. As described above, the first voltage range hysteresis period VRHP1 may be controlled by adjusting the difference between the first selection voltage V1s1 and the second selection voltage V1s2, the second voltage range hysteresis period VRHP2 may be controlled by adjusting the difference between the third selection voltage V2s1 and the fourth selection voltage V2s2, and the third voltage range hysteresis period VRHP3 may be controlled by adjusting the difference between the fifth selection voltage V3s1 and the sixth selection voltage V3s2.

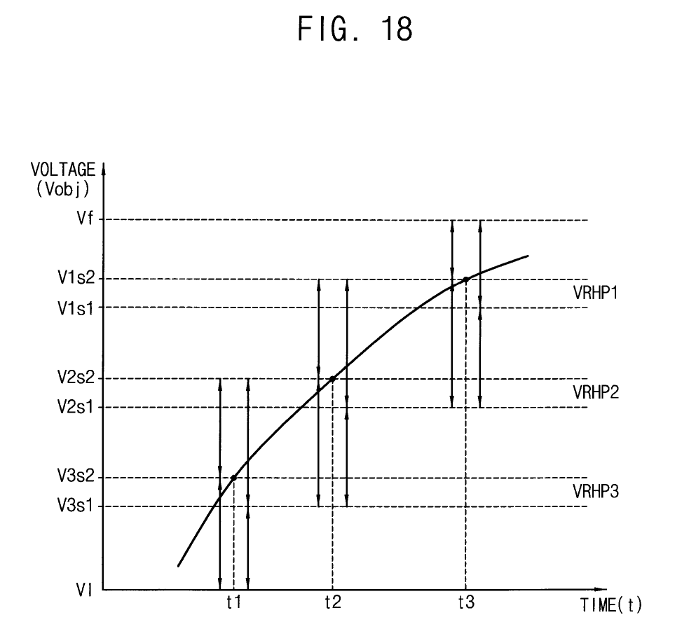

FIG. 19 is a block diagram illustrating a voltage supply circuit having a voltage range determination circuit of FIG. 8.

Referring to FIG. 19, the voltage supply circuit 500 may include the voltage range determination circuit 400, a decoding unit 520, and an amplifying unit 540.

The voltage range determination circuit 500 receives the input voltage Vin (e.g., a power voltage VPWR output from a battery) to generate the object voltage Vobj, and generates the first through nth output signal OUT1 through OUTn corresponding to the voltage range of the object voltage Vobj. As the input voltage Vin fluctuates due to external noise, the object voltage Vobj may also fluctuate. In an exemplary embodiment, the voltage range determination circuit 400 may include the object voltage generating unit 420 that generates the object voltage Vobj by performing the voltage division on the input voltage Vin (e.g., the power voltage VPWR), the selection voltage generating unit 440 that generates the first through nth selection voltage group having the selection voltages V1s1 through Vns2 by performing the voltage division on the reference voltage Vref, the comparison voltage selecting unit 460 that selects one of the selection voltages as the first through nth comparison voltage Vcom1 through Vcomn for the first through nth selection voltage group based on the first through nth output signal OUT1 through OUTn, and the output signal generating unit 480 that compares the object voltage Vobj with the first through nth comparison voltage Vcom1 through Vcomn to generate the first through nth output signal OUT1 through OUTn. Since the object voltage Vobj is a scaled down voltage of the input voltage Vin, the voltage range of the input voltage Vin may be determined by scaling up the voltage range of the object voltage Vobj.

The decoding unit 520 decodes the logic states of the first through nth output signal OUT1 through OUTn to generate a voltage gain control signal CTL. In an exemplary embodiment, the decoding unit 520 may generate the voltage gain control signal CTL for changing (e.g., increasing or decreasing) the voltage gain of the amplifying unit 540 based on the logic states of the first through nth output signal OUT1 through OUTn. The amplifying unit 540 changes the voltage gain based on the voltage gain control signal CTL output from the decoding unit 520. In an exemplary embodiment, the amplifying unit 540 may change (e.g., increase or decrease) the voltage gain based on the voltage gain control signal CTL, and may amplify an internal voltage by the voltage gain to generate an output voltage VOUT.

As described above, the voltage range determination circuit 400 may precisely determine the voltage range of the input voltage Vin (e.g., the power voltage VPWR) by setting the divided object voltage ranges, by setting the voltage range hysteresis periods at the boundaries of the divided object voltage ranges, by determining the voltage range of the object voltage Vobj based on the divided object voltage ranges, and by scaling up the voltage range of the object voltage Vobj. As a result, the power supply circuit 500 may precisely determine the voltage range of the input voltage Vin (e.g., the power voltage VPWR) even when the input voltage Vin (e.g., the power voltage VPWR) fluctuates due to external noise, and may generate the output voltage VOUT that is substantially stable by changing the voltage gain of the amplifying unit 540 based on the voltage gain control signal CTL output from the decoding unit 520. Thus, the power supply circuit 500 substantially operates as a voltage regulator such that the power supply circuit 500 may be used to supply the stable voltage in a display device of an electric device.

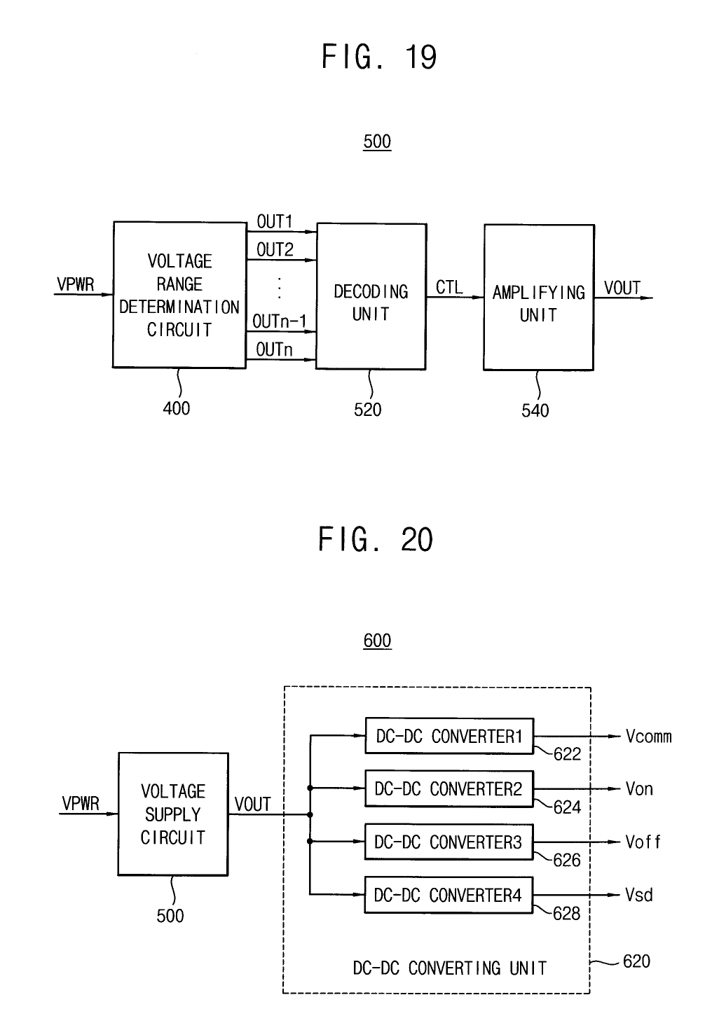

FIG. 20 is a block diagram illustrating a display driving voltage generator having a voltage supply circuit of FIG. 19.

Referring to FIG. 20, the display driving voltage generator 600 may include a voltage supply circuit 500 and a DC-DC converting unit 620.

The power supply circuit 500 receives the input voltage Vin (e.g., the power voltage VPWR), and supplies the output voltage VOUT that is substantially stable even when the input voltage Vin (e.g., the power voltage VPWR) fluctuates due to external noise. In an exemplary embodiment, the voltage supply circuit 500 may include the object voltage generating unit 420 that generates the object voltage Vobj by performing the voltage division on the input voltage Vin (e.g., the power voltage VPWR), the selection voltage generating unit 440 that generates the first through nth selection voltage group having the selection voltages V1s1 through Vns2 by performing the voltage division on the reference voltage Vref, the comparison voltage selecting unit 460 that selects one of the selection voltages as the first through nth comparison voltage Vcom1 through Vcomn for the first through nth selection voltage group based on the first through nth output signal OUT1 through OUTn, the output signal generating unit 480 that compares the object voltage Vobj with the first through nth comparison voltage Vcom1 through Vcomn to generate the first through nth output signal OUT1 through OUTn, the decoding unit 520 that decodes the first through nth output signal OUT1 through OUTn to generate the voltage gain control signal CTL, and the amplifying unit 540 that amplifies the internal voltage by the voltage gain to generate the output voltage VOUT.

The DC-DC converting unit 620 generates a plurality of display driving voltages (e.g., a gate-on voltage Von, a gate-off voltage Voff, a source driving voltage Vsd, and a common voltage Vcomm) based on the output voltage VOUT output from the voltage supply circuit 500. In an exemplary embodiment, the DC-DC converting unit 620 may include a first DC-DC converter 622 that generates the common voltage Vcomm based on the output voltage VOUT, a second DC-DC converter 624 that generates the gate-on voltage Von based on the output voltage VOUT, a third DC-DC converter 626 that generates the gate-off voltage Voff based on the output voltage VOUT, and a fourth DC-DC converter 628 that generates the source driving voltage Vsd based on the output voltage VOUT. As described above, the DC-DC converting unit 620 may output the display driving voltages generated by the first through fourth DC-DC converters 622, 624, 626, and 628.

Generally, an input DC voltage for the first through fourth DC-DC converters 622, 624, 626, and 628 should be within a certain range. Thus, the first through fourth DC-DC converters 622, 624, 626, and 628 may abnormally operate, or may be damaged when the input DC voltage is out of the certain range. Thus, the voltage supply circuit 500 may supply the output voltage VOUT that is substantially stable within the certain range to the first through fourth DC-DC converters 622, 624, 626, and 628 even when the input voltage Vin (e.g., the power voltage VPWR) fluctuates due to external noise. In detail, the voltage supply circuit 500 may change the voltage gain of the amplifying unit 540 based on the voltage range of the object voltage Vobj, and amplify the internal voltage by the voltage gain to generate the output voltage VOUT that is substantially stable within the certain range.

As a result, the display driving voltage generator 600 may achieve high operation reliability because the display driving voltage generator 600 successfully generates the display driving voltages (e.g., the gate-on voltage Von, the gate-off voltage Voff, the source driving voltage Vsd, and the common voltage Vcomm) even when the input voltage Vin (e.g., the power voltage VPWR) fluctuates due to external noise.

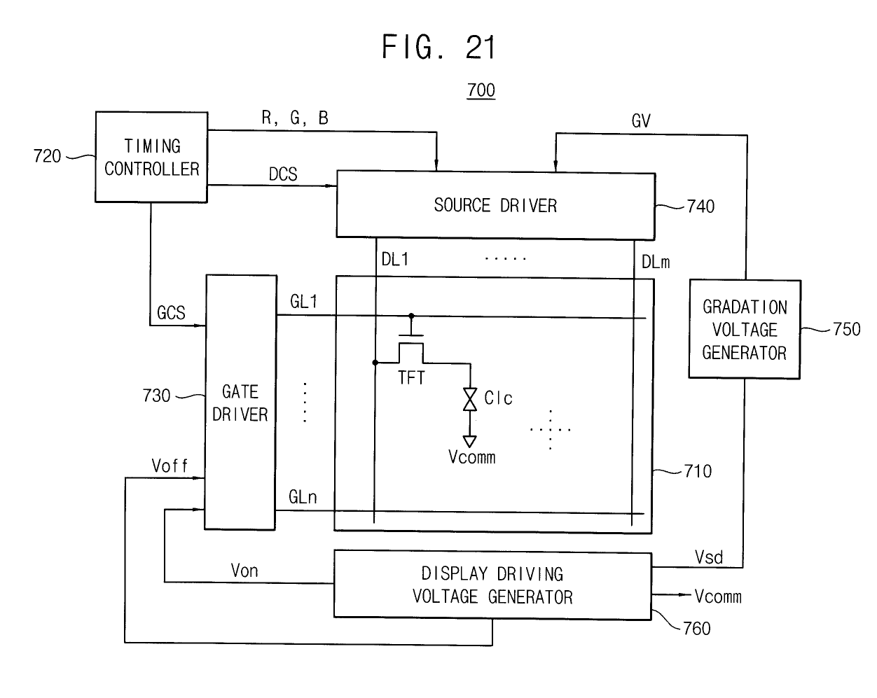

FIG. 21 is a block diagram illustrating an exemplary of a display device having a display driving voltage generator according to some exemplary embodiments.

Referring to FIG. 21, the display device 700 may include a display panel 710, a timing controller 720, a gate driver 730, a source driver 740, a gradation voltage generator 750, and a display driving voltage generator 760.

The display panel 710 may be a Liquid Crystal Display (LCD) panel. The display panel 710 includes a pixel matrix in which a plurality of pixels are formed at intersections of a plurality of gate lines GL1 through GLn, and a plurality of data lines DL1 through DLm. Each pixel may include a LCD cell Clc and a thin film transistor TFT. Here, the thin film transistor TFT turns on based on the gate-on voltage Von provided from the gate lines GL1 through GLn such that a gradation voltage GV provided from the data lines DL1 through DLm may be provided to the LCD cell Clc. In addition, the thin film transistor TFT turns off based on the gate-off voltage Voff provided from the gate lines GL1 through GLn such that the gradation voltage GV provided to the LCD cell Clc may be maintained. In an exemplary embodiment, each pixel may further include a storage capacitor that maintains the gradation voltage GV provided to the LCD cell Clc during one frame period.

The timing controller 720 generates a gate control signal GCS for controlling the gate driver 730 and a data control signal DCS for controlling the source driver 740, and provides the gate control signal GCS and the data control signal DCS to the gate driver 730 and the source driver 740, respectively. In addition, the timing controller 720 generates image signals R, G, and B, and provides the image signals R, G, and B to the source driver 740. In an exemplary embodiment, the gate control signal GCS may include a vertical synchronizing start signal, a gate clock signal, an output enable signal, etc. The data control signal DCS may include a horizontal synchronizing start signal, a load signal, a reverse signal, a data clock signal, etc. The gate driver 730 sequentially provides a gate-on voltage Von and a gate-off voltage Voff output from the display driving voltage generator 760 to the gate lines GL1 through GLn based on the gate control signal GCS. The source driver 740 sequentially receives the image signals R, G, and B from the timing controller 720 based on the data control signal DCS, and selects the gradation voltage GV corresponding to the image signals R, G, and B to provide the gradation voltage GV to the data lines DL1 through DLm.

The gradation voltage generator 750 generates the gradation voltage GV based on the source driving voltage Vsd output from the display driving voltage generator 760. In an exemplary embodiment, the gradation voltage generator 750 may generate the gradation voltage GV having a positive value, and the gradation voltage GV having a negative value in relation to the common voltage Vcomm. Thus, the display device 700 may periodically change a display arrangement direction by alternately providing the gradation voltage GV having a positive value and the gradation voltage GV having a negative value to the source driver 740. As a result, the degradation of the display panel 710 may be prevented. The display driving voltage generator 760 successfully generates the display driving voltages (e.g., the gate-on voltage Von, the gate-off voltage Voff, the source driving voltage Vsd, and the common voltage Vcomm) even when the power voltage VPWR output from the battery fluctuates due to external noise.

Above, a voltage range determination circuit, a voltage supply circuit, a display driving voltage generator, and a display device are illustrated. However, since the structures of the voltage range determination circuit, the voltage supply circuit, the display driving voltage generator, and the display device are exemplary, the structures of the voltage range determination circuit, the voltage supply circuit, the display driving voltage generator, and the display device are not limited thereto. The present inventive concept may be applied to an electric device that operates based on a power voltage output from a battery. For example, the present inventive concept may be applied to a desktop computer, a laptop computer, a digital camera, a video camcorder, a cellular phone, a personal digital assistant (PDA), a portable multimedia player (PMP), a MP3 player, a navigation system, a video phone, etc.

The foregoing is illustrative of exemplary embodiments and is not to be construed as limiting thereof. Although a few exemplary embodiments have been described, those skilled in the art will readily appreciate that many modifications are possible in the exemplary embodiments without materially departing from the novel teachings and advantages of the present inventive concept. Accordingly, all such modifications are intended to be included within the scope of the present inventive concept as defined in the claims. Therefore, it is to be understood that the foregoing is illustrative of various exemplary embodiments and is not to be construed as limited to the specific exemplary embodiments disclosed, and that modifications to the disclosed exemplary embodiments, as well as other exemplary embodiments, are intended to be included within the scope of the appended claims.

What is claimed is:

1. A voltage range determination circuit, comprising:
an object voltage generating unit configured to generate an object voltage based on an input voltage, the object voltage corresponding to a scaled-down voltage of the input voltage;
a selection voltage generating unit configured to generate a first selection voltage and a second selection voltage based on a reference voltage, the first selection voltage being smaller than the second selection voltage;
a comparison voltage selecting unit configured to select one of the first selection voltage and the second selection voltage as a comparison voltage, based on an output signal; and
an output signal generating unit configured to compare the object voltage with the comparison voltage to generate the output signal.

2. The voltage range determination circuit of claim 1, wherein a plurality of object voltage ranges include a first object voltage range and a second object voltage range, and
wherein a voltage range of the object voltage is determined based on a logic state of the output signal.

3. The voltage range determination circuit of claim 2, wherein the first object voltage range and the second object voltage range are changed by a voltage range hysteresis period based on the logic state of the output signal.

4. The voltage range determination circuit of claim 3, wherein the voltage range hysteresis period corresponds to a difference between the first selection voltage and the second selection voltage.

5. The voltage range determination circuit of claim 4, wherein a plurality of input voltage ranges include a first input voltage range and a second input voltage range, and
wherein the first input voltage range and the second input voltage range are determined by scaling up the first object voltage range and the second object voltage range, respectively.

6. The voltage range determination circuit of claim 5, wherein at a time when the object voltage becomes smaller than the comparison voltage as the input voltage decreases, the first object voltage range becomes narrower by the voltage range hysteresis period, and the second object voltage range becomes wider by the voltage range hysteresis period.

7. The voltage range determination circuit of claim 5, wherein at a time when the object voltage becomes greater than the comparison voltage as the input voltage increases, the first object voltage range becomes wider by the voltage range hysteresis period, and the second object voltage range becomes narrower by the voltage range hysteresis period.

8. The voltage range determination circuit of claim 5, wherein the object voltage is determined to be within the first object voltage range when the output signal has a first logic state, and the object voltage is determined to be within the second object voltage range when the output signal has a second logic state.

9. The voltage range determination circuit of claim 8, wherein the input voltage is determined to be within the first input voltage range when the object voltage is determined to be within the first object voltage range, and the input voltage is determined to be within the second input voltage range when the object voltage is determined to be within the second object voltage range.

10. The voltage range determination circuit of claim 1, wherein the object voltage generating unit comprises a plurality of resistors that generate the object voltage by voltage division of the input voltage.

11. The voltage range determination circuit of claim 1, wherein the selection voltage generating unit comprises a plurality of resistors that generate the first selection voltage and the second selection voltage by voltage division of the reference voltage.

12. The voltage range determination circuit of claim 1, wherein the comparison voltage selecting unit comprises a multiplexer that selectively outputs one of the first selection voltage and the second selection voltage as the comparison voltage based on the output signal.

13. The voltage range determination circuit of claim 1, wherein the output signal generating unit comprises a comparator that compares the object voltage with the comparison voltage to generate the output signal.

14. A voltage range determination circuit, comprising:
an object voltage generating unit configured to generate an object voltage by voltage division of an input voltage, the object voltage corresponding to a scaled-down voltage of the input voltage;
a selection voltage generating unit configured to generate a first through nth selection voltage group by performing a voltage division of a reference voltage, the first through nth selection voltage groups having a first through nth plurality of selection voltages;
a comparison voltage selecting unit configured to select one for each of the first through the nth plurality of selection voltages as a first through nth comparison voltages for the first through nth selection voltage groups based on a first through nth output signal, respectively; and
an output signal generating unit configured to compare the object voltage with the first through nth comparison voltages to generate the first through nth output signals.

15. The voltage range determination circuit of claim 14, wherein a plurality of object voltage ranges include a first through (n+1)th object voltage ranges, and
wherein the voltage range of the object voltage is determined based on logic states of the first through nth output signals.

16. The voltage range determination circuit of claim 15, wherein the first through (n+1)th object voltage ranges are changed based on the logic states of the first through nth output signals.

17. The voltage range determination circuit of claim 16, wherein a first through nth voltage range hysteresis periods correspond to differences between selection voltages of the first through nth selection voltage groups, respectively.

18. The voltage range determination circuit of claim 17, wherein a plurality of input voltage ranges include a first through nth input voltage range, and
wherein the first through nth input voltage range are determined by scaling up the first through nth object voltage range, respectively.

19. A method for a providing a steady output voltage, the method comprising:
generating an object voltage based on a portion of an output voltage of a voltage source;
generating a first selection voltage and a second selection voltage based on a reference voltage, the first selection voltage being smaller than the second selection voltage;
selecting one of the first selection voltage and the second selection voltage as a comparison voltage;
comparing the object voltage with the comparison voltage to generate an output signal; and
amplifying the object voltage based on the output signal,
wherein the selecting the one of the first and the second selection voltages as the comparison voltage is based on the output signal that is fed back.

20. The method of claim 1 further comprising:
adaptively changing the comparison voltage according to a predetermined voltage amount, the adaptively changing comprising, if the object voltage decreases below than the comparison voltage, the comparison voltage is increased by the predetermined amount; and
comparing the decreased object voltage that is fluctuating, with the increased comparison voltage to generate the output signal.

21. The method of claim 1 further comprising:
adaptively changing the comparison voltage according to a predetermined voltage amount, the adaptively changing comprising, if the object voltage increases above than the comparison voltage, the comparison voltage is decreased by the predetermined amount; and
comparing the increased object voltage that is fluctuating, with the decreased comparison voltage to generate the output signal.
